(19) United States
(12) Patent Application Publication
(10) Pub. No.: US 2025/0189705 A1
(43) Pub. Date: Jun. 12, 2025

(54) OPTICAL FILTER

(71) Applicant: AGC Inc., Tokyo (JP)

(72) Inventors: Takashi NAGATA, Shizuoka (JP); Takahiro SAKAGAMI, Shizuoka (JP); Kazuhiko SHIONO, Fukushima (JP); Yuichiro ORITA, Fukushima (JP)

(73) Assignee: AGC Inc., Tokyo (JP)

(21) Appl. No.: 19/059,903

(22) Filed: Feb. 21, 2025

Related U.S. Application Data
(63) Continuation of application No. PCT/JP2023/030943, filed on Aug. 28, 2023.

(30) Foreign Application Priority Data
Aug. 31, 2022 (JP) 2022-138363

(51) Int. Cl. G02B 5/20

(52) U.S. Cl. CPC G02B 5/208

(57) ABSTRACT

An optical filter includes a dielectric multilayer film 1, a resin film, a phosphate glass, and a dielectric multilayer film 2 in this order. The resin film includes a resin and a near-infrared ray absorbing dye having a maximum absorption wavelength in 690 nm to 800 nm in the resin, the resin film has a thickness of 10 μm or less, and the optical filter satisfies all of the spectral characteristics (i-1) to (i-5).

### CROSS-REFERENCE TO RELATED APPLICATIONS

This is a bypass continuation of International Application No. PCT/JP2023/030943 filed on Aug. 28, 2023, and claims priority from Japanese Patent Application No. 2022-138363 filed on Aug. 31, 2022, the entire content of which is incorporated herein by reference.

### TECHNICAL FIELD

The present invention relates to an optical filter that transmits visible light and shields near-infrared light.

### BACKGROUND ART

In an imaging device including a solid state image sensor, in order to satisfactorily reproduce a color tone and obtain a clear image, an optical filter that transmits light in a visible region (hereinafter, also referred to as “visible light”) and shields light in a near-infrared wavelength region (hereinafter, also referred to as “near-infrared light”) is used.

Examples of such an optical filter include various types such as a reflection type filter in which dielectric thin films having different refractive indices are alternately laminated on one surface or both surfaces of a transparent substrate (dielectric multilayer film) and light to be shielded is reflected by utilizing interference of light, an absorption type filter in which light to be shielded is absorbed by using a glass or a dye that absorbs light in a specific wavelength region, and a filter in which a reflection type filter and an absorption type filter are combined.

Patent Literatures 1 and 2 disclose an optical filter including a dielectric multilayer film and an absorbing layer containing a dye.

### CITATION LIST

### Patent Literature

### Patent Literature 1: WO2019/151348

### Patent Literature 2: WO2018/043564

### SUMMARY OF INVENTION

### Technical Problem

In an optical filter including a dielectric multilayer film, since an optical thickness of the dielectric multilayer film changes depending on an incident angle of light, there is a problem that a spectral transmittance curve changes depending on the incident angle. For example, according to the number of laminated layers of the multilayer film, a large change in transmittance in a visible light region due to interference caused by reflected light at interfaces of respective layers, that is, a ripple is generated, and the larger the incident angle of light is, the stronger the generation of the ripple is. When such a filter is used, spectral sensitivity of the solid state image sensor may be affected by the incident angle. In particular, with a reduction in height of camera modules in recent years, use under a condition of a high incident angle is assumed, and therefore an optical filter that is hardly affected by an incident angle is required.

Further, when an infrared sensor and an image sensor are used side by side, an infrared ray may be unintentionally taken into the image sensor, which may bring an adverse effect to an image. From the viewpoint of avoiding this problem, there is a demand for an optical filter capable of shielding a wavelength region of 900 nm to 1,000 nm in a near-infrared light region.

An object of the present invention is to provide an optical filter which is excellent in transmittance in a visible light region, has a small change in transmittance in the visible light region even at a high incident angle, and is excellent in light-shielding properties in a near-infrared light region, particularly, light-shielding properties in 900 nm to 1,000 nm.

### Solution to Problem

The present invention provides an optical filter having the following configuration.

[1] An optical filter including a dielectric multilayer film 1, a resin film, a phosphate glass, and a dielectric multilayer film 2 in this order, in which

the resin film includes a resin and a near-infrared ray absorbing dye having a maximum absorption wavelength in 690 nm to 800 nm in the resin,

the resin film has a thickness of 10 μm or less, and

the optical filter satisfies all of the following spectral characteristics (i-1) to (i-5).

(i-1) An average transmittance T_{430-550(0deg)AVE} at a wavelength of 430 nm to 550 nm and an incident angle of 0 degrees is 80% or more.

(i-2) An average transmittance T_{430-550(60deg)AVE} at a wavelength of 430 nm to 550 nm and an incident angle of 60 degrees is 80% or more.

(i-3) In a wavelength of 500 nm to 700 nm, a wavelength IR_{50(0deg)} at which a transmittance at an incident angle of 0 degrees is 50% is in a wavelength region of 600 nm to 660 nm.

(i-4) When a transmittance T_{n(0deg)} (n: any integer) at each wavelength is read at an incident angle of 0 degrees and an interval of 1 nm from a wavelength of 900 nm toward a wavelength of 1,000 nm, the number of n at which the transmittance T_{n(0deg)} is 0.04% or less is 20 or more.

(i-5) When a transmittance T_{n(40deg)} (n: any integer) at each wavelength is read at an incident angle of 40 degrees and an interval of 1 nm from a wavelength of 900 nm toward a wavelength of 1,000 nm, the number of n at which the transmittance In (40deg) is 0.04% or less is 20 or more.

### Advantageous Effects of Invention

According to the present invention, it is possible to provide an optical filter which is excellent in transmittance in a visible light region, has a small change in transmittance in the visible light region even at a high incident angle, and is excellent in light-shielding properties in a near-infrared light region, particularly, light-shielding properties in 900 nm to 1,000 nm.

### BRIEF DESCRIPTION OF DRAWINGS

FIG. 1 is a cross-sectional view schematically illustrating an example of an optical filter according to one embodiment.

FIG. 2 is a diagram illustrating a spectral transmittance curve of a phosphate glass.

FIG. 3 is a diagram illustrating a spectral transmittance curve of a resin film of Example 1-1.

FIG. 4 is a diagram illustrating spectral transmittance curves of an optical filter of Example 2-1.

FIG. 5 is a diagram illustrating spectral reflectance curves of the optical filter of Example 2-1.

FIG. 6 is a diagram illustrating spectral transmittance curves of an optical filter of Example 2-3.

FIG. 7 is a diagram illustrating spectral reflectance curves of the optical filter of Example 2-3.

FIG. 8 is a diagram illustrating spectral transmittance curves of an optical filter of Example 2-5.

FIG. 9 is a diagram illustrating spectral reflectance curves of the optical filter of Example 2-5.

### DESCRIPTION OF EMBODIMENTS

Hereinafter, embodiments of the present invention are described.

In the present description, a near-infrared ray absorbing dye may be abbreviated as an “NIR dye”, and an ultraviolet absorbing dye may be abbreviated as a “UV dye”.

In the present description, a compound represented by a formula (I) is referred to as a compound (I). The same applies to compounds represented by other formulae. A dye composed of the compound (I) is also referred to as a dye (I), and the same applies to other dyes. In addition, a group represented by the formula (I) is also referred to as a group (I), and the same applies to groups represented by other formulae.

In the present description, an internal transmittance is a transmittance obtained by subtracting an influence of interface reflection from a measured transmittance, which is represented by a formula of {measured transmittance (incident angle of 0 degrees)/(100−reflectance (incident angle of 5 degrees))}×100.

In the present description, a transmittance of, for example, 90% or more in a specific

wavelength region means that the transmittance does not fall below 90% in the entire wavelength region, that is, a minimum transmittance in the wavelength region is 90% or more. Similarly, a transmittance of, for example, 1% or less in a specific wavelength region means that the transmittance does not exceed 1% in the entire wavelength region, that is, a maximum transmittance in the wavelength region is 1% or less. The same applies to the internal transmittance. An average transmittance and an average internal transmittance in the specific wavelength region are the arithmetic mean of a transmittance and an internal transmittance per 1 nm in the wavelength region.

Spectral characteristics can be measured by using an ultraviolet-visible spectrophotometer.

### <Optical Filter>

In the present description, the word “to” that is used to express a numerical range includes upper and lower limits of the range.

An optical filter according to the present embodiment includes a dielectric multilayer film 1, a resin film, a phosphate glass, and a dielectric multilayer film 2 in this order.

Here, the resin film includes a resin and a near-infrared ray absorbing dye having a maximum absorption wavelength in 690 nm to 800 nm in the resin, and a thickness of the resin film is 10 μm or less.

By reflection characteristics of the dielectric multilayer film and absorption characteristics of the phosphate glass serving as near-infrared ray absorbing glass and a near-infrared ray absorbing dye, the optical filter as a whole can achieve an excellent transmittance in a visible light region and excellent light-shielding properties in a near-infrared light region.

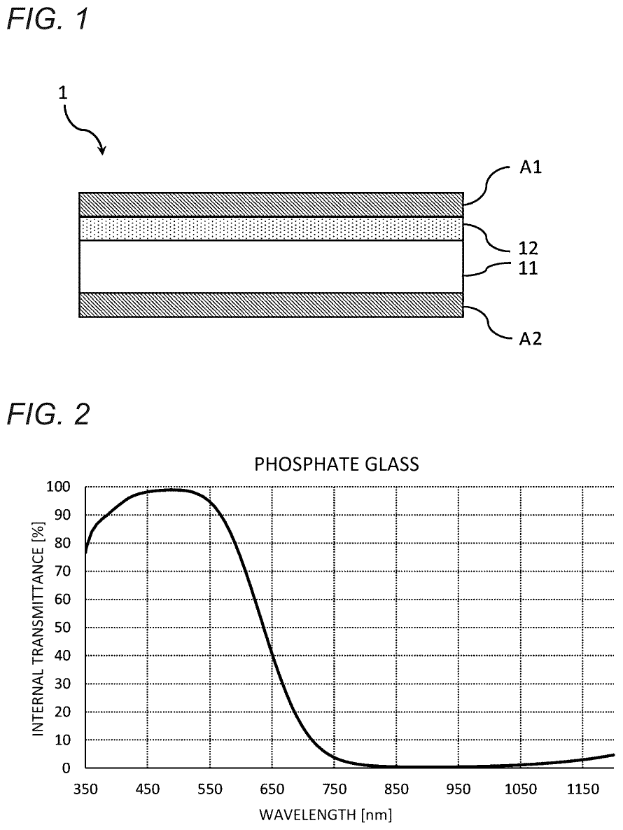

A configuration example of the optical filter according to the present embodiment is described with reference to the drawings. FIG. 1 is a cross-sectional view schematically illustrating an example of the optical filter according to one embodiment.

An optical filter 1 illustrated in FIG. 1 includes a dielectric multilayer film A1, a resin film 12, phosphate glass 11, and a dielectric multilayer film A2 in this order.

The optical filter according to the present embodiment satisfies all of the following spectral characteristics (i-1) to (i-5).

(i-1) An average transmittance T_{430-550(0deg)AVE} at a wavelength of 430 nm to 550 nm and an incident angle of 0 degrees is 80% or more.

(i-2) An average transmittance T_{430-550(60deg)AVE} at a wavelength of 430 nm to 550 nm and an incident angle of 60 degrees is 80% or more.

(i-3) In a wavelength of 500 nm to 700 nm, a wavelength IR_{50(0deg)} at which a transmittance at an incident angle of 0 degrees is 50% is in a wavelength region of 600 nm to 660 nm.

(i-4) When a transmittance T_{n(0deg)} (n: any integer) at each wavelength is read at an incident angle of 0 degrees and an interval of 1 nm from a wavelength of 900 nm toward a wavelength of 1,000 nm, the number of n at which the transmittance T_{n(0deg)} is 0.04% or less is 20 or more.

(i-5) When a transmittance T_{n(40deg)} (n: any integer) at each wavelength is read at an incident angle of 40 degrees and an interval of 1 nm from a wavelength of 900 nm toward a wavelength of 1,000 nm, the number of n at which the transmittance T_{n(40deg)} is 0.04% or less is 20 or more.

The optical filter according to the present embodiment that satisfies all of the spectral characteristics (i-1) to (i-5) particularly has a high transmittance of visible light as shown in the characteristic (i-1) and high light-shielding properties of particularly near-infrared light having a wavelength of 900 nm to 1,000 nm as shown in the characteristics (i-4) and (i-5). Further, as shown in the characteristics (i-1) and (i-2), a transmittance in a visible light region is not reduced even at a high incident angle, and a ripple in the visible light region is prevented.

Satisfying the spectral characteristic (i-1) means that a transmittance in a visible light region of 430 nm to 550 nm is excellent.

Satisfying the spectral characteristic (i-2) means that the transmittance in the visible light region of 430 nm to 550 nm is excellent even at a high incident angle.

The average transmittance T_{430-550(0deg)AVE} is preferably 85% or more, and more preferably 90% or more.

The average transmittance T_{430-550(60deg)AVE} is preferably 81% or more, and more preferably 83% or more.

The spectral characteristics (i-1) and (i-2) can be achieved, for example, by using a dielectric multilayer film having a low reflectance in the visible light region and by using a near-infrared ray absorbing dye and a phosphate glass having a high transmittance in the visible light region.

Satisfying the spectral characteristic (i-3) means that light in the near-infrared region can be shielded and visible transmitted light can be efficiently taken in.

The wavelength IR_{50(0deg)} is preferably in a wavelength region of 610 nm to 650 nm, and more preferably in a wavelength region of 615 nm to 640 nm.

Satisfying the spectral characteristic (i-4) means that light-shielding properties in a near-infrared light region of 900 nm to 1,000 nm are excellent.

Satisfying the spectral characteristic (i-5) means that the light-shielding properties in the near-infrared light region of 900 nm to 1,000 nm are excellent even at a high incident angle.

The number of n at which the transmittance T_{n(0deg)} is 0.04% or less is preferably 30 or more, and more preferably 40 or more.

The number of n at which the transmittance T_{n(40deg)} is 0.04% or less is preferably 30 or more, and more preferably 40 or more.

The spectral characteristics (i-4) and (i-5) can be achieved, for example, by using a dielectric multilayer film having reflection characteristics at the wavelength of 900 nm to 1,000 nm.

The optical filter according to the present embodiment preferably further satisfies the following spectral characteristics (i-6) and (i-7).

(i-6) An average transmittance T_{750-1200(0deg)AVE} at a wavelength of 750 nm to 1,200 nm and an incident angle of 0 degrees is 2% or less.

(i-7) An average transmittance T_{750-1200(40deg)AVE} at a wavelength of 750 nm to 1,200 nm and an incident angle of 40 degrees is 2% or less.

Satisfying the spectral characteristic (i-6) means that light-shielding properties in a near-infrared light region of 750 nm to 1,200 nm are excellent.

Satisfying the spectral characteristic (i-7) means that the light-shielding properties in the near-infrared light region of 750 nm to 1,200 nm are excellent even at a high incident angle.

The average transmittance T_{750-1200(0deg)AVE} is more preferably 1.5% or less, and further preferably 0.8% or less.

The average transmittance T_{750-1200(40deg)AVE} is more preferably 1% or less, and further preferably 0.5% or less.

The spectral characteristics (i-6) and (i-7) can be achieved, for example, by combining the absorption characteristics of the near-infrared ray absorbing dye and the phosphate glass and the reflection characteristics of the dielectric multilayer film that reflects near-infrared light to widely shield light.

The optical filter according to the present embodiment preferably further satisfies the following spectral characteristics (i-8) and (i-9).

(i-8) When a transmittance T_{n(0deg)} (n: any integer) at each wavelength is read at an incident angle of 0 degrees and an interval of 1 nm from a wavelength of 900 nm toward a wavelength of 1,000 nm, the number of n at which the transmittance In (Odeg) is 0.01% or less is 20 or more.

(i-9) When a transmittance T_{n(40deg)} (n: any integer) at each wavelength is read at an incident angle of 40 degrees and an interval of 1 nm from a wavelength of 900 nm toward a wavelength of 1,000 nm, the number of n at which the transmittance T_{n(40deg)} is 0.01% or less is 20 or more.

Satisfying the spectral characteristic (i-8) means that the light-shielding properties in the near-infrared light region of 900 nm to 1,000 nm are excellent.

Satisfying the spectral characteristic (i-9) means that the light-shielding properties in the near-infrared light region of 900 nm to 1,000 nm are excellent even at a high incident angle.

The number of n at which the transmittance T_{n(0deg)} is 0.01% or less is preferably 30 or more, and more preferably 40 or more.

The number of n at which the transmittance T_{n(40deg)} is 0.01% or less is preferably 25 or more, and more preferably 30 or more.

The spectral characteristics (i-8) and (i-9) can be achieved, for example, by using a dielectric multilayer film having reflection characteristics at the wavelength of 900 nm to 1,000 nm.

The optical filter according to the present embodiment preferably further satisfies the following spectral characteristics (i-10) and (i-11).

(i-10) An absolute value of a difference between the average transmittance T_{430-550(0deg)AVE} and the average transmittance T_{430-550(60deg)AVE} is 10% or less.

(i-11) An absolute value of a difference between a maximum transmittance T_{430-550(0deg)MAX} at an incident angle of 0 degrees and a maximum transmittance T_{430-550(60deg)MAX} at an incident angle of 60 degrees at a wavelength of 430 nm to 550 nm is 10% or less.

Satisfying the spectral characteristics (i-10) and (i-11) means that a change in transmittance of the visible light is small even at a high incident angle and the ripple is reduced.

The absolute value of the difference between the average transmittance T_{430-550(0deg)AVE} and the average transmittance T_{430-550(60deg)AVE} is more preferably 9% or less, and further preferably 8% or less.

The absolute value of the difference between the maximum transmittance T_{430-550(0deg)MAX} and the maximum transmittance T_{430-550(60deg)MAX} is more preferably 9% or less, and further preferably 8% or less.

The spectral characteristics (i-10) and (i-11) can be achieved, for example, by using a dielectric multilayer film having a low reflectance in the visible light region and by using the near-infrared ray absorbing dye and the phosphate glass having a high transmittance in the visible light region.

The optical filter according to the present embodiment preferably further satisfies the following spectral characteristics (i-12) to (i-17).

(i-12) When a dielectric multilayer film 2 side is set as an incident direction, an average reflectance R2_{430-550(5deg)AVE} at a wavelength of 430 nm to 550 nm and an incident angle of 5 degrees is 10% or less.

(i-13) When a dielectric multilayer film 2 side is set as an incident direction, an average reflectance R2_{430-550(60deg)AVE} at a wavelength of 430 nm to 550 nm and an incident angle of 60 degrees is 10% or less.

(i-14) When a dielectric multilayer film 2 side is set as an incident direction, a maximum reflectance R2_{430-550(5deg)MAX} at a wavelength of 430 nm to 550 nm and an incident angle of 5 degrees is 15% or less.

(i-15) When a dielectric multilayer film 2 side is set as an incident direction, a maximum reflectance R2_{430-550(60deg)MAX} at a wavelength of 430 nm to 550 nm and an incident angle of 60 degrees is 15% or less.

(i-16) When a dielectric multilayer film 2 side is set as an incident direction, when a reflectance R2_{n(5deg)} (n: any integer) at each wavelength is read at an incident angle of 5 degrees and an interval of 1 nm from a wavelength of 900 nm toward a wavelength of 1,000 nm, the number of n at which the reflectance R2_{n(5deg)} is 95% or more is 30 or more.

(i-17) When a dielectric multilayer film 2 side is set as an incident direction, when a reflectance R2_{n(40deg)} (n: any integer) at each wavelength is read at an incident angle of 40 degrees and an interval of 1 nm from a wavelength of 900 nm toward a wavelength of 1,000 nm, the number of n at which the reflectance R2_{n(40deg)} is 95% or more is 25 or more.

Satisfying the spectral characteristics (i-12) to (i-15) means that the reflectance in the visible light region is small even at a high incident angle and a reflection ripple is small.

The average reflectance R2_{430-550(5deg)AVE} is more preferably 5% or less, and further preferably 3% or less.

The average reflectance R2_{430-550(60deg)AVE} is more preferably 9.5% or less, and further preferably 9% or less.

The maximum reflectance R2_{430-550(5deg)MAX} is more preferably 10% or less, and further preferably 5% or less.

The maximum reflectance R2_{430-550(60deg)MAX} is more preferably 13% or less, and further preferably 10% or less.

The spectral characteristics (i-12) to (i-15) can be achieved, for example, by using a dielectric multilayer film 2 having a low reflectance in the visible light region.

Satisfying the spectral characteristics (i-16) and (i-17) means that light in the near-infrared light region having a wavelength of 900 nm to 1,000 nm is shielded by the reflection characteristics.

The number of n at which the reflectance R2_{n(5deg)} is 95% or more is more preferably 40 or more, and further preferably 50 or more.

The number of n at which the reflectance R2_{n(40deg)} is 95% or more is more preferably 30 or more, and further preferably 40 or more.

The spectral characteristics (i-16) and (i-17) can be achieved, for example, by using a dielectric multilayer film 2 having a high reflectance at the wavelength of 900 nm to 1,000 nm.

The optical filter according to the present embodiment preferably further satisfies the following spectral characteristics (i-18) and (i-19).

(i-18) When a dielectric multilayer film 2 side is set as an incident direction, an absolute value of a difference between an average reflectance R2_{430-550(5deg)AVE} at an incident angle of 5 degrees and an average reflectance R2_{430-550(60deg)AVE} at an incident angle of 60 degrees at a wavelength of 430 nm to 550 nm is 10% or less.

(i-19) When a dielectric multilayer film 2 side is set as an incident direction, an absolute value of a difference between a maximum reflectance R2_{430-550(5deg)MAX} at an incident angle of 5 degrees and a maximum reflectance R2_{430-550(60deg)MAX} at an incident angle of 60 degrees at a wavelength of 430 nm to 550 nm is 10% or less.

Satisfying the spectral characteristics (i-18) and (i-19) means that a change in reflectance in the visible light region is small even at a high incident angle and a reflection ripple is small.

The absolute value of the difference between the average reflectance R2_{430-550(5deg)AVE} and the average reflectance R2_{430-550(60deg)AVE} is more preferably 9% or less, and further preferably 8% or less.

The absolute value of the difference between the maximum reflectance R2_{430-550(5deg)MAX} and the maximum reflectance R2_{430-550(60deg)MAX} is more preferably 9% or less, and further preferably 8% or less.

The spectral characteristics (i-18) and (i-19) can be achieved, for example, by using the dielectric multilayer film 2 having a low reflectance in the visible light region.

The optical filter according to the present embodiment preferably further satisfies the following spectral characteristic (i-20).

(i-20) When a dielectric multilayer film 2 side is set as an incident direction, when a reflectance R2_{n(5deg)} (n: any integer) at each wavelength is read at an incident angle of 5 degrees and an interval of 1 nm from a wavelength of 900 nm toward a wavelength of 1,000 nm, the number of n at which the reflectance R2_{n(5deg)} is 98% or more is 30 or more.

Satisfying the spectral characteristic (i-20) means that light in the near-infrared light region having a wavelength of 900 nm to 1,000 nm is shielded by the reflection characteristics.

The number of n at which the reflectance R2_{n(5deg)} is 98% or more is more preferably 40 or more, and further preferably 50 or more.

The spectral characteristic (i-20) can be achieved, for example, by using the dielectric multilayer film 2 having a high reflectance at the wavelength of 900 nm to 1,000 nm.

### <Dielectric Multilayer Film>

In the optical filter according to the present embodiment, the dielectric multilayer film 1 is laminated on a resin film side, and the dielectric multilayer film 2 is laminated on a phosphate glass side.

As shown in the spectral characteristics (i-16), (i-17), and (i-20) of the above optical filter, it is preferable that light in the near-infrared light region having a wavelength of 900 nm to 1,000 nm is shielded by reflection characteristics of the dielectric multilayer film 2. In addition, since a dielectric multilayer film designed to reflect near-infrared light in a wide range is likely to be affected by the incident angle, a near-infrared light region for enhancing the reflection characteristics is preferably specialized to the wavelength of 900 nm to 1,000 nm. By combining reflection characteristics of such a specific wavelength region with absorption characteristics of the near-infrared ray absorbing dye having a maximum absorption wavelength in 690 nm to 800 nm and absorption characteristics of the phosphate glass, light in the near-infrared light region having a wavelength of 750 nm to 1,200 nm can be shielded in a wide range

On the other hand, as shown in the spectral characteristics (i-12) to (i-15) of the above optical filter, the dielectric multilayer film 2 preferably has small reflection characteristics in the visible light region. Thus, an optical filter is obtained in which the spectral characteristics in the visible light region are less likely to change depending on the incident angle and the ripple is reduced.

As described above, the dielectric multilayer film 2 is preferably designed as a reflection layer that reflects the near-infrared light of 900 nm to 1,000 nm.

The dielectric multilayer film 1 is preferably designed as an antireflection layer.

The dielectric multilayer film 1 and the dielectric multilayer film 2 are composed of,

for example, a dielectric multilayer film in which dielectric films having different refractive indices are laminated. More specifically, examples of the dielectric films include a dielectric film having a low refractive index (low refractive index film), a dielectric film having a medium refractive index (medium refractive index film), and a dielectric film having a high refractive index (high refractive index film), and the dielectric multilayer film 1 and the dielectric multilayer film 2 are composed of a dielectric multilayer film in which two or more of those dielectric films are laminated.

A refractive index of the high refractive index film at a wavelength of 500 nm is preferably 1.6 or more, more preferably 1.8 to 2.5, and particularly preferably 2.2 to 2.5. Examples of a material of the high refractive index film include Ta₂O₅, TiO₂, TiO, and Nb₂O₅. Other commercially available products thereof include OS50 (Ti₃O₅), OS10 (Ti₄O₇), OA500 (mixture of Ta₂O₅ and ZrO₂), and OA600 (mixture of Ta₂O₅ and TiO₂) manufactured by Canon Optron, Inc. Among those, TiO₂ is preferable from the viewpoint of reproducibility in film formability and refractive index, stability, and the like.

A refractive index of the medium refractive index film at a wavelength of 500 nm is preferably 1.6 or more and less than 2.2. Examples of a material of the medium refractive index film include ZrO₂, Nb₂O₅, Al₂O₃, HfO₂, OM-4, OM-6 (mixtures of Al₂O₃ and ZrO₂), and OA-100 sold by Canon Optron, Inc., and H4 and M2 (alumina lanthania) sold by Merck KGaA. Among those, Al₂O₃-based compounds and mixtures of Al₂O₃ and ZrO₂ are preferable from the viewpoint of reproducibility in film formability and refractive index, stability, and the like.

A refractive index of the low refractive index film at a wavelength of 500 nm is preferably less than 1.6, and more preferably 1.38 to 1.5. Examples of a material of the low refractive index film include SiO₂, SiOₓN_{y}, and MgF₂. Other commercially available products thereof include S4F and S5F (mixtures of SiO₂ and Al₂O₃) manufactured by Canon Optron, Inc. Among those, SiO₂ is preferable from the viewpoint of reproducibility in film formability, stability, economic efficiency, and the like.

In at least one of the dielectric multilayer film 1 and the dielectric multilayer film 2, [sum T(H) of QWOT of dielectric films having relatively high refractive index]/[sum T(L) of QWOT of dielectric films having relatively low refractive index] is preferably 1.6 or more. Accordingly, it is likely to obtain a dielectric multilayer film that reflects near-infrared light having a wavelength of 900 nm to 1,000 nm and satisfies the above spectral characteristics in which reflection of visible light is prevented, and it is preferable that at least the dielectric multilayer film 2 satisfies such a ratio relation.

Here, a quarter wave optical thickness (QWOT) is an optical thickness of λ/4 of a wavelength, and is calculated based on a physical thickness using the following formula.

$$QWOT = physical thickness / central wavelength \text{} ( 500 nm ) \times 4 \times refractive index at wavelength of 500 nm .$$

When the dielectric multilayer film is a laminate of a low refractive index film and a high refractive index film, the sum T(H) of QWOT is a sum of QWOT of the high refractive index film, and the sum T(L) of QWOT is a sum of QWOT of the low refractive index film.

When the dielectric multilayer film is a laminate of a low refractive index film and a medium refractive index film, the sum T(H) of QWOT is a sum of QWOT of the medium refractive index film, and the sum T(L) of QWOT is a sum of QWOT of the low refractive index film.

When the dielectric multilayer film is a laminate of a medium refractive index film and a high refractive index film, the sum T(H) of QWOT is a sum of QWOT of the high refractive index film, and the sum T(L) of QWOT is a sum of QWOT of the medium refractive index film.

It is preferable that at least one of the dielectric multilayer film 1 and the dielectric multilayer film 2 is a multilayer film in which a H2 layer and an M2 layer, each defined below, are alternately laminated in 10 or more layers.

H₂ layer: a single layer having a refractive index of 1.8 or more and 2.5 or less and a QWOT of 1.1 or more and 3.5 or less.

M₂ layer: a single layer or a multilayer present between two H2 layers and having a sum of QWOT of 1.2 or more and 1.8 or less.

The above specific laminated structure is a structure in which single layers (H₂ layers) having a large refractive index and a large optical thickness and layers (M₂ layers) whose total optical thickness is within a predetermined range are alternately laminated in 10 or more layers. With such a structure, a dielectric multilayer film that reflects near-infrared light having a wavelength of 900 nm to 1,000 nm and has a low reflectance of visible light is easily obtained.

The M₂ layer may be a single layer or a multilayer as long as it satisfies a predetermined optical thickness, but from the viewpoint of obtaining smoother spectral characteristics, it is preferable that the M₂ layer is composed of a multilayer, and a minimum thickness of a single layer is preferably 5 nm or more, and more preferably 10 nm or more. A refractive index of the dielectric film constituting the M₂ layer is preferably equal to or lower than a refractive index of the H₂ layer.

It is preferable that at least the dielectric multilayer film 2 has the above specific laminated structure.

When the dielectric multilayer film 2 has the above laminated structure, the layer closest to the phosphate glass among the H₂ layer and the M₂ layer is preferably the H₂ layer. The H₂ layer closest to the phosphate glass may be directly laminated on the phosphate glass, or another layer not corresponding to either the H₂ layer or the M₂ layer may be present between the H₂ layer closest to the phosphate glass and the phosphate glass.

In the dielectric multilayer film 2, a total number of laminated layers of dielectric multilayer film is preferably 10 or more, more preferably 20 or more, and further preferably 30 or more. However, when the total number of laminated layers is increased, warpage or the like occurs, or the thickness thereof is increased, so that the total number of laminated layers is preferably 110 or less, more preferably 80 or less, and still more preferably 60 or less.

A thickness (physical thickness) of the dielectric multilayer film 2 is preferably 1 μm to 6 μm as a whole.

When the optical filter is to be mounted on an imaging device, since the dielectric multilayer film 1 is generally on a sensor side, the dielectric multilayer film 1 is preferably designed as an antireflection layer. The total number of laminated layers of the dielectric multilayer film 1 is preferably 40 or less, more preferably 30 or less, and further preferably 20 or less, and is preferably 6 or more.

A thickness (physical thickness) of the dielectric multilayer film 1 is preferably 0.2 μm to 1.0 μm as a whole.

For formation of the dielectric multilayer film, for example, a vacuum film formation process such as a CVD method, a sputtering method, or a vacuum deposition method, a wet film formation process such as a spraying method or a dipping method, or the like can be used.

In both cases where the dielectric multilayer film is a reflection layer and where the dielectric multilayer film is an antireflection layer, the dielectric multilayer film may provide predetermined optical characteristics by one layer (one group of dielectric multilayer films) or may provide the predetermined optical characteristics by two or more layers. When two or more layers are provided, the respective dielectric multilayer films may have the same configuration or different configurations.

When the optical filter is mounted on the imaging device, the dielectric multilayer film 2 laminated on a glass surface is generally disposed on a lens side, and the dielectric multilayer film 1 laminated on a resin film surface is generally disposed on a sensor side.

### <Phosphate Glass>

The phosphate glass in the optical filter of the present invention functions as an infrared ray absorbing glass.

The phosphate glass preferably satisfies all of the following spectral characteristics (ii-1) to (ii-5).

(ii-1) An internal transmittance T₄₅₀ at a wavelength of 450 nm is 92% or more. (ii-2) An average internal transmittance T_{450-600AVE} at a wavelength of 450 nm to 600 nm is 90% or more.

(ii-3) IR50 at which an internal transmittance is 50% is in a wavelength range of 625 nm to 650 nm.

(ii-4) An average internal transmittance T_{750-1000AVE} at a wavelength of 750 nm to 1,000 nm is 2.5% or less.

(ii-5) An average internal transmittance T_{1000-1200AVE} at a wavelength of 1,000 nm to 1,200 nm is 7% or less.

Satisfying the spectral characteristic (ii-1) means that a transmittance in a blue light region is excellent, and satisfying the spectral characteristic (ii-2) means that the transmittance in the visible light region of 450 nm to 600 nm is excellent.

The internal transmittance T₄₅₀ is more preferably 93% or more, and further preferably 95% or more.

The average internal transmittance T_{450-600AVE} is more preferably 94% or more, and further preferably 95% or more.

Satisfying the spectral characteristic (ii-3) means that light in the near-infrared region can be shielded and visible transmitted light can be efficiently taken in.

IR50 is more preferably in a range of 625 nm to 645 nm, and further preferably in a range of 625 nm to 640 nm.

Satisfying the spectral characteristic (ii-4) means that the light-shielding properties in the near-infrared region of 750 nm to 1,000 nm are excellent.

The average internal transmittance T_{750-1000AVE} is more preferably 2% or less, and further preferably 1.2% or less.

Satisfying the spectral characteristic (ii-5) means that the light-shielding properties in an infrared region of 1,000 nm to 1,200 nm are excellent.

The average internal transmittance T_{1000-1200AVE} is more preferably 2.3% or less, and further preferably 2.2% or less.

It is preferable that the phosphate glass start to absorb near-infrared light from a region of 625 nm to 650 nm as shown in the above characteristic (ii-3), and exhibits high light-shielding properties after 750 nm as shown in the above characteristic (ii-4). Accordingly, the light-shielding properties of the above-described dielectric multilayer film can be compensated.

In the present invention, the phosphate glass preferably contains copper ions. By containing copper ions that absorb light having a wavelength in the vicinity of 900 nm, near-infrared light of 700 nm to 1,200 nm can be shielded. The phosphate glass also includes a phosphosilicate glass in which a part of a skeleton of the glass is formed of SiO₂.

For example, it is preferable that the phosphate glass contains the following components constituting glass. Respective content ratios of the following glass constituent components are expressed in mass % in terms of oxides.

P₂O₅ is a main component forming the glass, and is an essential component for enhancing a near-infrared ray cutting property. When a content of P₂O₅ is 40% or more, an effect thereof can be sufficiently obtained, and when the content of P₂O₅ is 80% or less, problems such as glass instability and reduction in weather resistance are less likely to occur. Therefore, the content of P₂O₅ is preferably 40% to 80%, more preferably 52% to 78%, further preferably 54% to 77%, still more preferably 56% to 76%, and most preferably 60% to 75%.

Al₂O₃ is a main component forming glass, and is a component for enhancing strength of the glass, enhancing the weather resistance of the glass, and the like. When a content of Al₂O₃ is 0.5% or more, an effect thereof can be sufficiently obtained, and when the content of Al₂O₃ is 20% or less, problems such as glass instability and reduction in near-infrared ray cutting property are less likely to occur. Therefore, the content of Al₂O₃ is preferably 0.5% to 20%, more preferably 1.0% to 20%, further preferably 2.0% to 18%, still more preferably 3.0% to 17%, particularly preferably 4.0% to 16%, and most preferably 5.0% to 15.5%.

R₂O (where R₂O is one or more components selected from Li₂O, Na₂O, K₂O, Rb₂O, and Cs₂O) is a component for lowering a melting temperature of the glass, lowering a liquid phase temperature of the glass, stabilizing the glass, and the like. When a total content of R₂O (ΣR₂O) is 0.5% or more, an effect thereof is sufficiently obtained, and when the total content of R₂O is 20% or less, glass instability is less likely to occur, which is preferable. Therefore, the total content of R₂O is preferably 0.5% to 20%, more preferably 1% to 19%, further preferably 1.5% to 18%, still more preferably 2.0% to 17%, particularly preferably 2.5% to 16%, and most preferably 3.0% to 15.5%.

Li₂O is a component for lowering the melting temperature of the glass, lowering the liquid phase temperature of the glass, stabilizing the glass, and the like. A content of Li₂O is preferably 0% to 15%. When the content of Li₂O is 15% or less, problems such as glass instability and reduction in near-infrared ray cutting property are less likely to occur, which is preferable. The content of Li₂O is more preferably 0% to 8%, further preferably 0% to 7%, still more preferably 0% to 6%, and most preferably 0% to 5%.

Na₂O is a component for lowering the melting temperature of the glass, lowering the liquid phase temperature of the glass, stabilizing the glass, and the like. A content of Na₂O is preferably 0% to 15%. When the content of Na₂O is 15% or less, glass instability is less likely to occur, which is preferable. The content of Na₂O is more preferably 0.5% to 14%, further preferably 1% to 13%, still more preferably 2% to 13%, and most preferably 3% to 13%.

K₂O is a component having effects such as lowering the melting temperature of the glass and lowering the liquid phase temperature of the glass. A content of K₂O is preferably 0% to 20%. When the content of K₂O is 20% or less, glass instability is less likely to occur, which is preferable. The content of K₂O is more preferably 0.5% to 19%, further preferably 1% to 18%, still more preferably 2% to 17%, and most preferably 3% to 16%.

Rb₂O is a component having effects such as lowering the melting temperature of the glass and lowering the liquid phase temperature of the glass. A content of Rb₂O is preferably 0% to 15%. When the content of Rb₂O is 15% or less, glass instability is less likely to occur, which is preferable. The content of Rb₂O is more preferably 0.5% to 14%, further preferably 1% to 13%, still more preferably 2% to 13%, and most preferably 3% to 13%.

Cs₂O is a component having effects such as lowering the melting temperature of the glass and lowering the liquid phase temperature of the glass. A content of Cs₂O is preferably 0% to 15%. When the content of Cs₂O is 15% or less, glass instability is less likely to occur, which is preferable. The content of Cs₂O is more preferably 0.5% to 14%, further preferably 1% to 13%, still more preferably 2% to 13%, and most preferably 3% to 13%.

When two or more of the above alkali metal components represented by R₂O are added at the same time, a mixed alkali effect is generated in the glass, and a mobility of R⁺ ions is reduced. Accordingly, when the glass comes into contact with water, a hydration reaction caused by ion exchange between H⁺ ions in water molecules and the R⁺ ions in the glass is inhibited, and the weather resistance of the glass is improved. Therefore, the glass of the present embodiment preferably contains two or more components selected from Li₂O, Na₂O, K₂O, Rb₂O, and Cs₂O. In this case, the total content (ΣR₂O) of R₂O (where R₂O is Li₂O, Na₂O, K₂O, Rb₂O, and Cs₂O) is preferably 7% to 18% (where 7% is excluded). When the total content of R₂O is more than 7%, the effect thereof is sufficiently obtained, and when the total content of R₂O is 18% or less, problems such as glass instability, reduction in near-infrared ray cutting property, and reduction in strength of the glass are less likely to occur, which is preferable. Therefore, ΣR₂O is preferably more than 7% and 18% or less, more preferably 7.5% to 17%, further preferably 8% to 16%, still more preferably 8.5% to 15%, and most preferably 9% to 14%.

R′O (where R′O is one or more components selected from CaO, MgO, BaO, SrO, and ZnO) is a component for lowering the melting temperature of the glass, lowering the liquid phase temperature of the glass, stabilizing the glass, enhancing the strength of the glass, and the like. A total content of R′O (ΣR′O) is preferably 0% to 40%. When the total content of R′O is 40% or less, problems such as glass instability, reduction in near-infrared ray cutting property, and reduction in strength of the glass are less likely to occur, which is preferable. The total content of R′O is more preferably 0% to 35%, further preferably 0% to 30%, still more preferably 0% to 25%, particularly preferably 0% to 20%, and most preferably 0% to 15%.

CaO is a component for lowering the melting temperature of the glass, lowering the liquid phase temperature of the glass, stabilizing the glass, enhancing the strength of the glass, and the like. A content of CaO is preferably 0% to 10%. When the content of CaO is 10% or less, problems such as glass instability and reduction in near-infrared ray cutting property are less likely to occur, which is preferable. The content of CaO is more preferably 0% to 8%, further preferably 0% to 6%, still more preferably 0% to 5%, and most preferably 0% to 4%.

MgO is a component for lowering the melting temperature of the glass, lowering the liquid phase temperature of the glass, stabilizing the glass, enhancing the strength of the glass, and the like. A content of MgO is preferably 0% to 15%. When the content of MgO is 15% or less, problems such as glass instability and reduction in near-infrared ray cutting property are less likely to occur, which is preferable. The content of MgO is more preferably 0% to 13%, further preferably 0% to 10%, still more preferably 0% to 9%, and most preferably 0% to 8%.

BaO is a component for lowering the melting temperature of the glass, lowering the liquid phase temperature of the glass, stabilizing the glass, and the like. A content of BaO is preferably 0% to 40%. When the content of BaO is 40% or less, problems such as glass instability and reduction in near-infrared ray cutting property are less likely to occur, which is preferable. The content of BaO is more preferably 0% to 30%, further preferably 0% to 20%, still more preferably 0% to 10%, and most preferably 0% to 5%.

SrO is a component for lowering the melting temperature of the glass, lowering the liquid phase temperature of the glass, stabilizing the glass, and the like. A content of SrO is preferably 0% to 10%. When the content of SrO is 10% or less, problems such as glass instability and reduction in near-infrared ray cutting property are less likely to occur, which is preferable. The content of SrO is more preferably 0% to 8%, further preferably 0% to 7%, and most preferably 0% to 6%.

ZnO has effects such as lowering the melting temperature of the glass and lowering the liquid phase temperature of the glass. A content of ZnO is preferably 0% to 15%. When the content of ZnO is 15% or less, problems such as glass instability, deterioration in solubility of the glass, and reduction in near-infrared ray cutting property are less likely to occur, which is preferable. The content of ZnO is more preferably 0% to 13%, further preferably 0% to 10%, still more preferably 0% to 9%, and most preferably 0% to 8%.

CuO is a component for cutting near-infrared rays. When a content of CuO is 0.5% or more, an effect thereof and an effect of increasing a transmittance of light in the visible region of the glass obtained in the case where MoO₃ to be described later is contained can be sufficiently obtained, and when the content of CuO is 40% or less, problems such as generation of devitrification foreign matters in the glass and reduction in transmittance of light in a visible region are less likely to occur, which is preferable. The content of CuO is more preferably 1.0% to 35%, further preferably 1.5% to 30%, still more preferably 2.0% to 25%, and most preferably 2.5% to 20%.

MoO₃ is a component for increasing the transmittance of light in the visible region of the glass, and is preferably contained together with CuO. The inventor prepared a phosphate glass containing Cu (however, not containing a fluorine component) and a phosphate glass additionally containing Mo with respect to the glass, and confirmed optical characteristics thereof. As a result, the inventor confirmed that in the latter glass, a transmittance of light having a wavelength of 400 nm to 540 nm was significantly increased as compared to that in the former glass. This phenomenon, although it is a hypothesis, is considered to be due to the following.

Mo is known to exist in a glass as Mo⁶⁺ (hexavalent). However, when Mo and Cu are co-doped in the phosphate glass, Cut in the glass releases an electron (e⁻) and becomes Cu²⁺ (Cu⁺→Cu²⁺+e⁻), and Mo⁶⁺ receives the electron released by Cu⁺ and becomes Mo⁵⁺ (pentavalent) (Mo⁶⁺+e⁻→Mo⁵⁺). As a result, a proportion of Cu⁺ (monovalent) that has absorption characteristics in the vicinity of a wavelength of 300 nm to 600 nm is reduced, and the transmittance of light having a wavelength of 400 nm to 540 nm is increased. It is considered that since Mo⁵⁺ has a characteristic of absorbing light having a wavelength of about 400 nm, a transmittance of light having a wavelength of about 400 nm is not increased. In the related art, a phosphate glass containing Cu and Mo has not been known, and the above is considered to be a new finding found by the present inventors.

When a content of MoO₃ is 0.01% or more, the effect of increasing the transmittance of light in the visible region of the glass can be sufficiently obtained, and when the content of MoO₃ is 10% or less, problems such as reduction in near-infrared ray cutting property and generation of devitrification foreign matters in the glass are less likely to occur, which is preferable. The content of MoO₃ is more preferably 0.02% to 9%, further preferably 0.03% to 8%, still more preferably 0.04% to 7%, and most preferably 0.05% to 6%.

In the phosphate glass in the optical filter of the present embodiment, F may be contained in a range of 10% or less in order to enhance the weather resistance. When a content of F is 10% or less, problems such as reduction in near-infrared ray cutting property and generation of devitrification foreign matters in the glass are less likely to occur, which is preferable. The content of F is more preferably 9% or less, further preferably 8% or less, still more preferably 7% or less, particularly preferably 6% or less, and most preferably 5% or less.

B₂O₃ may be contained in a range of 10% or less for stabilizing the glass. When a content of B₂O₃ is 10% or less, problems such as deterioration in weather resistance of the glass and reduction in near-infrared ray cutting property are less likely to occur, which is preferable. The content of B₂O₃ is preferably 9% or less, more preferably 8% or less, further preferably 7% or less, still more preferably 6% or less, and most preferably 5% or less.

Among the above components, SiO₂, GeO₂, ZrO₂, SnO₂, TiO₂, CeO₂, WO₃, Y₂O₃, La₂O₃, Gd₂O₃, Yb₂O₃, and Nb₂O₅ may be contained in a range of 5% or less in order to improve the weather resistance of the glass. When a content of these components is 5% or less, problems such as generation of devitrification foreign matters in the glass and reduction in near-infrared ray cutting property are less likely to occur, which is preferable. The content of these components is preferably 4% or less, further preferably 3% or less, particularly preferably 2% or less, and still more preferably 1% or less.

Any of Fe₂O₃, Cr₂O₃, Bi₂O₃, NiO, V₂O₅, MnO₂, and CoO is a component that reduces

the transmittance of light in the visible region by being present in the glass. Therefore, it is preferable that these components are not substantially contained in the glass.

In the present invention, the expression “a specific component is not substantially contained” means that the component is not intentionally added, and does not exclude inclusion of the component to the extent that the component is unavoidably mixed in from raw materials, or the like, and does not affect desired properties.

A thickness of the phosphate glass is preferably 0.5 mm or less and more preferably 0.3 mm or less from the viewpoint of a reduction in height of camera modules, and is preferably 0.10 mm or more and more preferably 0.15 mm or more from the viewpoint of maintenance of device strength.

The phosphate glass can be prepared as follows, for example.

First, raw materials are weighed and mixed so as to fall within the above composition range (mixing step). The raw material mixture is accommodated in a platinum crucible, and heated and melted at a temperature of 700° C. to 1,400° C. in an electric furnace (melting step). After being sufficiently stirred and refined, the raw material mixture is cast into a mold, cut and polished to form a flat plate having a predetermined thickness (molding step).

In the melting step of the above manufacturing method, the highest temperature of the glass during glass melting is preferably 1,400° C. or lower. When the highest temperature of the glass during glass melting is higher than the above temperature, transmittance characteristics may deteriorate. The above temperature is more preferably 1,350° C. or lower, further preferably 1,300° C. or lower, and still more preferably 1,250° C. or lower.

In addition, when the temperature in the above melting step is too low, problems such as occurrence of devitrification during melting and requirement of a long time for burn through may occur, and thus the temperature is preferably 700° C. or higher, and more preferably 800° C. or higher.

### <Resin Film>

The resin film in the optical filter of the present invention includes the resin and the near-infrared ray absorbing dye having a maximum absorption wavelength in 690 nm to 800 nm in the resin. Here, the resin refers to a resin constituting the resin film.

The resin film preferably satisfies all of the following spectral characteristics (iii-1) to (iii-3).

(iii-1) An internal transmittance T₄₅₀ at a wavelength of 450 nm is 85% or more.

(iii-2) An average internal transmittance T_{450-600AVE} at a wavelength of 450 nm to 600 nm is 90% or more.

(iii-3) A wavelength IR50 at which an internal transmittance is 50% is in a range of 620 nm to 750 nm.

Satisfying the spectral characteristic (iii-1) means that a transmittance in a blue light region is excellent.

The internal transmittance T₄₅₀ is more preferably 95% or more, and further preferably 98% or more.

Satisfying the spectral characteristic (iii-2) means that the transmittance in the visible light region of 450 nm to 600 nm is excellent.

The average internal transmittance T_{450-600AVE} is more preferably 92% or more, and further preferably 94% or more.

Satisfying the spectral characteristic (iii-3) means that light in the near-infrared region can be shielded and visible transmitted light can be efficiently taken in.

The wavelength IR50 is more preferably in a range of 625 nm to 645 nm, and further preferably in a range of 625 nm to 640 nm.

Since the resin film of the present invention contains a dye having a maximum absorption wavelength in 690 nm to 800 nm, a near-infrared light region in the vicinity of 700 nm where the light-shielding properties are slightly weak in the phosphate glass can be shielded by absorption characteristics of the dye.

Examples of the near-infrared ray absorbing dye include at least one selected from the group consisting of a cyanine dye, a phthalocyanine dye, a squarylium dye, a naphthalocyanine dye, and a diimonium dye, and one thereof or a plurality thereof as a mixture can be used. Among those, the squarylium dye and the cyanine dye are preferable from the viewpoint of easily exhibiting the effect of the present invention.

A content of the near-infrared ray absorbing dye in the resin film is preferably 0.1 parts by mass to 30 parts by mass, and more preferably 0.1 parts by mass to 20 parts by mass with respect to 100 parts by mass of the resin. When two or more compounds are combined, the above content is a sum of respective compounds.

The resin film may contain other dyes, for example, an ultraviolet light-absorbing dye, as long as the effect of the present invention is not impaired.

Examples of the ultraviolet light-absorbing dye include an oxazole dye, a merocyanine dye, a cyanine dye, a naphthalimide dye, an oxadiazole dye, an oxazine dye, an oxazolidine dye, a naphthalic acid dye, a styryl dye, an anthracene dye, a cyclic carbonyl dye, and a triazole dye. Among those, the merocyanine dye is particularly preferable. In addition, these dyes may be used alone, or may be used in combination of two or more kinds thereof.

The resin is not limited as long as it is a transparent resin, and one or more kinds of transparent resins selected from a polyester resin, an acrylic resin, an epoxy resin, an ene-thiol resin, a polycarbonate resin, a polyether resin, a polyarylate resin, a polysulfone resin, a polyethersulfone resin, a poly(p-phenylene) resin, a polyarylene ether phosphine oxide resin, a polyamide resin, a polyimide resin, a polyamide-imide resin, a polyolefin resin, a cyclic olefin resin, a polyurethane resin, a polystyrene resin, and the like are used. These resins may be used alone, or may be used by mixing two or more kinds thereof.

One or more kinds of resins selected from the polyimide resin, the polycarbonate resin, the polyester resin, and the acrylic resin are preferable from the viewpoint of spectral characteristics, a glass transition temperature (Tg), and adhesion of the resin film.

When a plurality of dyes are used, these dyes may be contained in the same resin film or may be contained in different resin films.

The resin film can be formed by dissolving or dispersing a dye, a resin or a raw material component of the resin, and respective components blended as necessary in a solvent to prepare a coating solution, applying the coating solution to a support, drying the coating solution, and further curing the coating solution as necessary. The support in this case may be the phosphate glass used for the filter, or may be a peelable support used only when the resin film is to be formed. In addition, the solvent may be a dispersion medium capable of stably dispersing components or a solvent capable of dissolving components.

The coating solution may contain a surfactant in order to improve voids due to fine bubbles, depressions due to adhesion of foreign matters and the like, and repelling in a drying step. Further, for the application of the coating solution, for example, a dip coating method, a cast coating method, or a spin coating method can be used. The above coating solution is applied onto the support and then dried to form a resin film. When the coating solution contains a raw material component of the transparent resin, a curing process such as thermal curing or photocuring is further performed.

The resin film can also be manufactured into a film shape by extrusion molding. A substrate can be manufactured by laminating the obtained film-shaped resin film on the phosphate glass and integrating the resin film and the phosphate glass by thermal press fitting or the like.

The optical filter may have one layer of the resin film, or may have two or more layers of the resin film. When the optical filter has two or more layers of the resin film, respective layers may have the same configuration or different configurations.

A thickness of the resin film is 10 μm or less and preferably 5 μm or less from the viewpoint of in-plane thickness distribution and appearance quality in a substrate after coating, and is preferably 0.5 μm or more from the viewpoint of exhibiting desired spectral characteristics at an appropriate dye concentration. When the optical filter has two or more layers of the resin film, a total thickness of the respective resin films is preferably within the above range.

The optical filter according to the present embodiment may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have a high visible light transmittance and have light absorbing properties in a wide range of an infrared wavelength region exceeding 1,200 nm, and thus can be used in the case where light-shielding properties of infrared light are required.

For example, when the optical filter according to the present embodiment is used in an imaging device such as a digital still camera, an imaging device having excellent color reproducibility can be provided. Such an imaging device includes a solid state image sensor, an imaging lens, and the optical filter according to the present embodiment. The optical filter according to the present embodiment can be used, for example, by being disposed between the imaging lens and the solid state image sensor, or by being directly attached to the solid state image sensor, the imaging lens, or the like of the imaging device via an adhesive layer.

As described above, the present description discloses the following optical filter and the like.

[1] An optical filter including a dielectric multilayer film 1, a resin film, a phosphate glass, and a dielectric multilayer film 2 in this order, in which

the resin film includes a resin and a near-infrared ray absorbing dye having a maximum absorption wavelength in 690 nm to 800 nm in the resin,

the resin film has a thickness of 10 μm or less, and

the optical filter satisfies all of the following spectral characteristics (i-1) to (i-5).

(i-1) An average transmittance T_{430-550(0deg)AVE} at a wavelength of 430 nm to 550 nm and an incident angle of 0 degrees is 80% or more.

(i-2) An average transmittance T_{430-550(60deg)AVE} at a wavelength of 430 nm to 550 nm and an incident angle of 60 degrees is 80% or more.

(i-3) In a wavelength of 500 nm to 700 nm, a wavelength IR_{50(0deg)} at which a transmittance at an incident angle of 0 degrees is 50% is in a wavelength region of 600 nm to 660 nm.

(i-4) When a transmittance T_{n(0deg)} (n: any integer) at each wavelength is read at an incident angle of 0 degrees and an interval of 1 nm from a wavelength of 900 nm toward a wavelength of 1,000 nm, the number of n at which the transmittance T_{n(0deg)} is 0.04% or less is 20 or more.

(i-5) When a transmittance T_{n(40deg)} (n: any integer) at each wavelength is read at an incident angle of 40 degrees and an interval of 1 nm from a wavelength of 900 nm toward a wavelength of 1,000 nm, the number of n at which the transmittance T_{n(40deg)} is 0.04% or less is 20 or more.

[2] The optical filter according to [1], further satisfying the following spectral characteristics (i-6) and (i-7).

(i-6) An average transmittance T_{750-1200(0deg)AVE} at a wavelength of 750 nm to 1,200 nm and an incident angle of 0 degrees is 2% or less.

(i-7) An average transmittance T_{750-1200(40deg)AVE} at a wavelength of 750 nm to 1,200 nm and an incident angle of 40 degrees is 2% or less.

[3] The optical filter according to [1] or [2], further satisfying the following spectral characteristics (i-8) and (i-9).

(i-8) When the transmittance T_{n(0deg)} (n: any integer) at each wavelength is read at an incident angle of 0 degrees and an interval of 1 nm from a wavelength of 900 nm toward a wavelength of 1,000 nm, the number of n at which the transmittance T_{n(0deg)} is 0.01% or less is 20 or more.

(i-9) When the transmittance T_{n(40deg)} (n: any integer) at each wavelength is read at an incident angle of 40 degrees and an interval of 1 nm from a wavelength of 900 nm toward a wavelength of 1,000 nm, the number of n at which the transmittance T_{n(40deg)} is 0.01% or less is 20 or more.

[4] The optical filter according to any of [1] to [3], further satisfying the following spectral characteristics (i-10) and (i-11).

(i-10) An absolute value of a difference between the average transmittance T_{430-550(0deg)AVE} and the average transmittance T_{430-550(60deg)AVE} is 10% or less.

(i-11) An absolute value of a difference between a maximum transmittance T_{430-550(0deg)MAX} at an incident angle of 0 degrees and a maximum transmittance T_{430-550(60deg)MAX} at an incident angle of 60 degrees at a wavelength of 430 nm to 550 nm is 10% or less.

[5] The optical filter according to any of [1] to [4], further satisfying the following spectral characteristics (i-12) to (i-17).

(i-12) When a dielectric multilayer film 2 side is set as an incident direction, an average reflectance R2_{430-550(5deg)AVE} at a wavelength of 430 nm to 550 nm and an incident angle of 5 degrees is 10% or less.

(i-13) When a dielectric multilayer film 2 side is set as an incident direction, an average reflectance R2_{430-550(60deg)AVE} at a wavelength of 430 nm to 550 nm and an incident angle of 60 degrees is 10% or less.

(i-14) When a dielectric multilayer film 2 side is set as an incident direction, a maximum reflectance R2_{430-550(5deg)MAX} at a wavelength of 430 nm to 550 nm and an incident angle of 5 degrees is 15% or less.

(i-15) When a dielectric multilayer film 2 side is set as an incident direction, a maximum reflectance R2_{430-550(60deg)MAX} at a wavelength of 430 nm to 550 nm and an incident angle of 60 degrees is 15% or less.

(i-16) When a dielectric multilayer film 2 side is set as an incident direction, when a reflectance R2_{n(5deg)} (n: any integer) at each wavelength is read at an incident angle of 5 degrees and an interval of 1 nm from a wavelength of 900 nm toward a wavelength of 1,000 nm, the number of n at which the reflectance R2_{n(5deg)} is 95% or more is 30 or more.

(i-17) When a dielectric multilayer film 2 side is set as an incident direction, when a reflectance R2_{n(40deg)} (n: any integer) at each wavelength is read at an incident angle of 40 degrees and an interval of 1 nm from a wavelength of 900 nm toward a wavelength of 1,000 nm, the number of n at which the reflectance R2_{n(40deg)} is 95% or more is 25 or more.

[6] The optical filter according to any of [1] to [5], further satisfying the following spectral characteristics (i-18) and (i-19).

(i-18) When a dielectric multilayer film 2 side is set as an incident direction, an absolute value of a difference between an average reflectance R2_{430-550(5deg)AVE} at an incident angle of 5 degrees and an average reflectance R2_{430-550(60deg)AVE} at an incident angle of 60 degrees at a wavelength of 430 nm to 550 nm is 10% or less.

(i-19) When a dielectric multilayer film 2 side is set as an incident direction, an absolute value of a difference between a maximum reflectance R2_{430-550(5deg)MAX} at an incident angle of 5 degrees and a maximum reflectance R2_{430-550(60deg)MAX} at an incident angle of 60 degrees at a wavelength of 430 nm to 550 nm is 10% or less.

[7] The optical filter according to any of [1] to [6], further satisfying the following spectral characteristic (i-20).

(i-20) When a dielectric multilayer film 2 side is set as an incident direction, when a reflectance R2_{n(5deg)} (n: any integer) at each wavelength is read at an incident angle of 5 degrees and an interval of 1 nm from a wavelength of 900 nm toward a wavelength of 1,000 nm, the number of n at which the reflectance R2_{n(5deg)} is 98% or more is 30 or more.

[8] The optical filter according to any of [1] to [7], in which at least one of the dielectric multilayer film 1 and the dielectric multilayer film 2 is a laminate of dielectric films having different refractive indices, and has [sum of QWOT of dielectric films having relatively high refractive index]/[sum of QWOT of dielectric films having relatively low refractive index] of 1.6 or more.

[9] The optical filter according to any of [1] to [8], in which

at least one of the dielectric multilayer film 1 and the dielectric multilayer film 2 is a multilayer film in which H₂ layers and M₂ layers defined below are alternately laminated in 10 or more layers.

H₂ layer: a single layer having a refractive index of 1.8 or more and 2.5 or less and a QWOT of 1.1 or more and 3.5 or less.

M₂ layer: a single layer or a multilayer present between two H₂ layers and having a sum of QWOT of 1.2 or more and 1.8 or less.

The optical filter according to any of [1] to [9], in which

the phosphate glass satisfies all of the following spectral characteristics (ii-1) to (ii-5).

(ii-1) An internal transmittance T₄₅₀ at a wavelength of 450 nm is 92% or more.

(ii-2) An average internal transmittance T_{450-600AVE} at a wavelength of 450 nm to 600 nm is 90% or more.

(ii-3) IR50 at which an internal transmittance is 50% is in a wavelength range of 625 nm to 650 nm.

(ii-4) An average internal transmittance T_{750-1000AVE} at a wavelength of 750 nm to 1,000 nm is 2.5% or less.

(ii-5) An average internal transmittance T_{1000-1200AVE} at a wavelength of 1,000 nm to 1,200 nm is 7% or less.

The optical filter according to any of [1] to [10], in which

the phosphate glass contains, in terms of mass % based on oxide,

40% to 80% of P₂O₅,

0.5% to 20% of Al₂O₃,

0.5% to 20% of ΣR₂O (where R₂O is one or more components selected from Li₂O, Na₂O, K₂O, Rb₂O, and Cs₂O, and ΣR₂O is a total content of R₂O),

0% to 40% of ΣR′O (where R′O is one or more components selected from CaO, MgO, BaO, SrO, and ZnO, and ER′O is a total content of R′O), and

0.5% to 40% of CuO.

The optical filter according to any of [1] to [11], in which

the near-infrared ray absorbing dye contains a squarylium dye, and

the resin film satisfies all of the following spectral characteristics (iii-1) to (iii-3).

(iii-1) An internal transmittance T₄₅₀ at a wavelength of 450 nm is 85% or more.

(iii-2) An average internal transmittance T_{450-600AVE} at a wavelength of 450 nm to 600 nm is 90% or more.

(iii-3) A wavelength IR50 at which an internal transmittance is 50% is in a range of 620 nm to 750 nm.

An imaging device including the optical filter according to any of [1] to [12].

### EXAMPLES

Next, the present invention is described more specifically with reference to examples.

For measurement of each spectral characteristic, an ultraviolet-visible spectrophotometer (UH-4150 type, manufactured by Hitachi High-Tech Corporation) was used.

The spectral characteristic in the case where an incident angle is not particularly specified is a value measured at an incident angle of 0 degrees (in a direction perpendicular to a main surface of the optical filter).

Dyes used in respective examples are as follows.

Compound 1 (squarylium compound): synthesized based on WO2017/135359.

Compound 2 (cyanine compound): synthesized based on a method described in Dyes and Pigments, 73, 344 to 352 (2007).

Compound 3 (merocyanine compound): synthesized based on the description of German Patent No. 10109243.

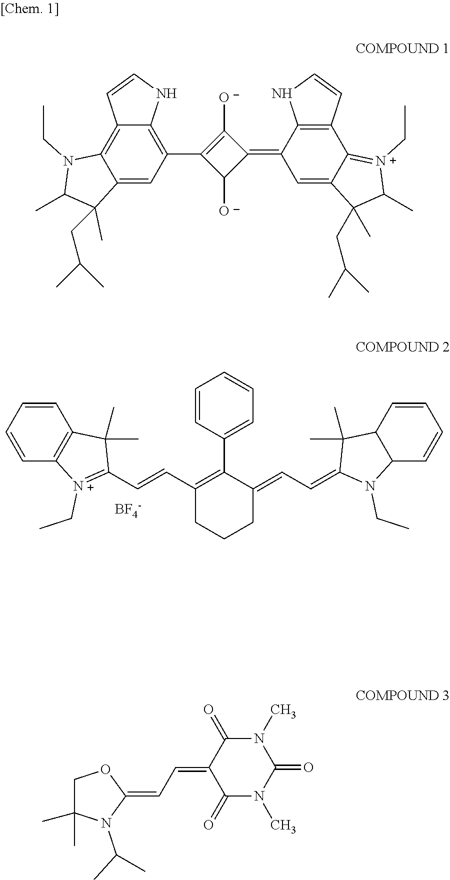

### <Spectral Characteristics of Dye in Resin>

A polyimide resin (“C3G30G” (trade name), manufactured by Mitsubishi Gas Chemical Company, Inc., refractive index: 1.59) was dissolved in a mixture of γ-butyrolactone (GBL):cyclohexanone=1:1 (mass ratio) to prepare a polyimide resin solution having a resin concentration of 8.5 mass %.

Each of the dyes of the above compounds 1 to 3 was added to the resin solution at a concentration of 7.5 parts by mass with respect to 100 parts by mass of the resin, and stirred and dissolved at 50° C. for 2 hours to obtain a coating solution. The obtained coating solution was applied to alkaline glass (D263 glass, manufactured by SCHOTT, thickness: 0.2 mm) by a spin coating method to form a coating film having a thickness of about 1.0 μm.

With respect to the obtained coating film, a spectral transmittance curve in a wavelength range of 350 nm to 1,200 nm was measured using the ultraviolet-visible spectrophotometer.

The spectral characteristics in the polyimide resin of the above respective compounds 1 to 3 are shown in Table 1 below. The spectral characteristics shown in the following table were evaluated in terms of internal transmittance in order to avoid an influence of reflection at an air interface and a glass interface.

TABLE 1

| Dye | Maximum absorption |
|---|---|
| number | wavelength in resin |
| Compound 1 | 752 nm |
| Compound 2 | 773 nm |
| Compound 3 | 400 nm |

### <Spectral Characteristics of Glass>

As the near-infrared ray absorbing glass, a phosphate glass and a fluorophosphate glass having compositions shown in the following table were prepared.

Raw materials were weighed and mixed so as to have the compositions (mass % based on oxide) shown in Table 2 below, and the mixture was put into a crucible having an internal volume of about 400 cc and melted in an air atmosphere for 2 hours. Thereafter, the mixture was refined, stirred, and cast into a rectangular mold having a length of 100 mm, a width of 80 mm, and a height of 20 mm that was preheated to about 300° C. to 500° C., and then slowly cooled at about 1° C./min to obtain a plate-like glass having a length of 40 mm, a width of 30 mm, and a predetermined thickness (mm), both surfaces of which were optically polished.

TABLE 2

| | Phosphate | Fluorophosphate |
|---|---|---|
| (mass %) | glass | glass |
| P₂O₅ | 68.53 | 41.45 |
| Al₂O₃ | 11.32 | 6.27 |
| Li₂O | 0.00 | 4.87 |
| Na₂O | 3.15 | 0.00 |
| K₂O | 9.04 | 0.00 |
| CaO | 0.00 | 3.37 |
| SrO | 0.00 | 7.75 |
| BaO | 0.00 | 11.91 |
| MoO₃ | 0.30 | 0.00 |
| CuO | 7.66 | 3.08 |
| F | 0.00 | 21.28 |
| Total | 100 | 100 |

With respect to each glass, a spectral transmittance curve in the wavelength range of 350 nm to 1,200 nm was measured using the ultraviolet-visible spectrophotometer.

The obtained spectral characteristics are shown in Table 3 below. The spectral characteristics shown in the following table were evaluated in terms of internal transmittance in order to avoid an influence of reflection at an air interface and a glass interface.

A spectral transmittance curve of the phosphate glass is illustrated in FIG. 2.

TABLE 3

| | | | Fluoro- | Fluoro- |
|---|---|---|---|---|
| | | Phos- | phos- | phos- |
| | | phate | phate | phate |
| Glass | Type | glass | glass 1 | glass 2 |
| Spectral | Thickness (mm) | 0.292 | 0.200 | 0.400 |
| charac- | 450 nm internal transmit- | 98.2 | 98.6 | 97.4 |
| teristics | tance (%) | | | |
| | 450-600 nm average | 94.1 | 96.2 | 92.9 |
| | internal transmittance (%) | | | |
| | IR50 (nm) | 636 | 663 | 627 |
| | 750-1,000 nm average | 0.9 | 14.2 | 2.2 |
| | internal transmittance (%) | | | |
| | 1,000-1,200 nm average | 2.1 | 31.0 | 10.0 |
| | internal transmittance (%) | | | |

As described above, it is understood that the phosphate glass used has a higher transmittance in the visible light region and is more excellent in light-shielding properties in the near-infrared ray region as compared to the fluorophosphate glass.

### Examples 1-1 to 1-3: Spectral Characteristics of Resin Film

The dyes of the compounds 1 to 3 were mixed with a polyimide resin solution prepared in the same manner as in calculation of the spectral characteristics of the above compounds at a concentration shown in Table 4 below, and stirred and dissolved at 50° C. for 2 hours to obtain a coating solution. The obtained coating solution was applied to an alkaline glass (D263 glass, manufactured by SCHOTT, thickness: 0.2 mm) by a spin coating method to form a resin film having a thickness of 3.0 μm.

With respect to the obtained resin film, a spectral transmittance curve in the wavelength range of 350 nm to 1,200 nm was measured using the ultraviolet-visible spectrophotometer.

The obtained results of the spectral characteristics are shown in Table 4 below. The spectral characteristics shown in the following table were evaluated in terms of internal transmittance in order to avoid an influence of reflection at an air interface and a glass interface.

A spectral transmittance curve of the resin film of Example 1-1 is illustrated in FIG. 3.

Examples 1-1 to 1-3 are reference examples.

TABLE 4

| | | Exam- | Exam- | Exam- |
|---|---|---|---|---|
| | | ple 1-1 | ple 1-2 | ple 1-3 |
| Added | Compound 1 (λMAX: 752 nm) | 2.33 | 2.33 | 1.17 |
| amount | Compound 2 (λMAX: 773 nm) | 2.60 | 6.75 | 0.83 |
| of dye | Compound 3 (λMAX: 400 nm) | 6.19 | 6.19 | 6.19 |
| (mass %) | Total | 11.11 | 15.27 | 8.19 |
| Spectral | 450 nm internal transmittance | 91.6 | 85.7 | 96.1 |
| charac- | (%) | | | |
| teristics | 450-600 nm average internal | 96.2 | 93.1 | 98.2 |
| of resin | transmittance (%) | | | |
| film | IR50 (nm) | 683 | 656 | 726 |

### Example 2-1: Spectral Characteristics of Optical Filter

A resin film was formed on one main surface of the phosphate glass in the same manner as in Example 1-1. TiO₂ (refractive index at wavelength of 500 nm: 2.47) and SiO₂ (refractive index at wavelength of 500 nm: 1.48) were laminated on a surface of the resin film in an order and a thickness (nm) shown in Table 5 below by vapor deposition to form a dielectric multilayer film 1. TiO₂ and SiO₂ were laminated on the other main surface of the phosphate glass in an order and a thickness (nm) shown in Table 5 below by vapor deposition to form a dielectric multilayer film 2.

In this manner, an optical filter having a configuration of dielectric multilayer film 2 (front surface)/phosphate glass/resin film/dielectric multilayer film 1 (rear surface) was prepared.

### Examples 2-2 to 2-4: Spectral Characteristics of Optical Filter

Optical filters were prepared in the same manner as in Example 2-1 except that the dielectric multilayer film 1 and the dielectric multilayer film 2 were changed to have configurations shown in Tables 5 and 6 below.

### Examples 2-5 and 2-6: Spectral Characteristics of Optical Filter

Optical filters were prepared in the same manner as in Example 2-1 except that the phosphate glass was changed to a fluorophosphate glass 1 or a fluorophosphate glass 2, and the resin film, the dielectric multilayer film 1, and the dielectric multilayer film 2 were changed to have configurations shown in Table 6 below.

TABLE 5

| | | Optical filter: Example 2-1 | | | | Optical filter: Example 2-2 | | | | Optical filter: Example 2-3 | | | |
|---|---|---|---|---|---|---|---|---|---|---|---|---|---|
| | | | | | Sum | | | | Sum | | | | Sum |
| | | | Physical | | of | | Physical | | of | | Physical | | of |
| | | Material | thickness | QWOT | QWOT | Material | thickness | QWOT | QWOT | Material | thickness | QWOT | QWOT |
| Dielectric | 14 | SiO₂ | 102.9 | 1.22 | | SiO₂ | 102.9 | 1.22 | | | | | |
| multilayer | 13 | TiO₂ | 32.6 | 0.64 | | TiO₂ | 32.6 | 0.64 | | | | | |
| film 1 | 12 | SiO₂ | 11.2 | 0.13 | | SiO₂ | 11.2 | 0.13 | | | | | |
| | 11 | TiO₂ | 83.8 | 1.65 | | TiO₂ | 83.8 | 1.65 | | | | | |
| | 10 | SiO₂ | 31.9 | 0.38 | | SiO₂ | 31.9 | 0.38 | | | | | |
| | 9 | TiO₂ | 21.9 | 0.43 | | TiO₂ | 21.9 | 0.43 | | | | | |
| | 3 | SiO₂ | 102.0 | 1.21 | | SiO₂ | 102.0 | 1.21 | | | | | |
| | 7 | TiO₂ | 9.0 | 0.18 | | TiO₂ | 9.0 | 0.18 | | | | | |
| | 6 | SiO₂ | 87.8 | 1.04 | | SiO₂ | 87.8 | 1.04 | | SiO₂ | 95.4 | 1.13 | |
| | 5 | TiO₂ | 21.4 | 0.42 | | TiO₂ | 21.4 | 0.42 | | TiO₂ | 116.6 | 2.30 | |
| | 4 | SiO₂ | 59.4 | 0.70 | | SiO₂ | 59.4 | 0.70 | | SiO₂ | 40.0 | 0.47 | |
| | 3 | TiO₂ | 23.5 | 0.46 | | TiO₂ | 23.5 | 0.46 | | TiO₂ | 18.5 | 0.37 | |
| | 2 | SiO₂ | 65.4 | 0.78 | | SiO₂ | 65.4 | 0.78 | | SiO₂ | 63.3 | 0.75 | |
| | 1 | TiO₂ | 12.6 | 0.25 | | TiO₂ | 12.6 | 0.25 | | TiO₂ | 6.0 | 0.12 | |

| | | Resin film | | | | | | | | | | | | | | |
|---|---|---|---|---|---|---|---|---|---|---|---|---|---|---|---|---|
| | | Resin film 1-1 | | | | | Resin film 1-1 | | | | | Resin film 1-1 | | | | |
| | | Glass | | | | | | | | | | | | | | |
| | | Phosphate glass | | | | | Phosphate glass | | | | | Phosphate glass | | | | |
| Dielectric | 1 | TiO₂ | 13.0 | 0.26 | 0.64 | — | TiO₂ | 12.8 | 0.25 | 0.65 | — | TiO₂ | 13.0 | 0.26 | 0.64 | — |
| multilayer | 2 | SiO₂ | 32.4 | 0.38 | | | SiO₂ | 33.5 | 0.40 | | | SiO₂ | 32.4 | 0.38 | | |
| film 2 | 3 | TiO₂ | 122.1 | 2.41 | — | H2 | TiO₂ | 125.5 | 2.48 | — | H2 | TiO₂ | 122.1 | 2.41 | — | H2 |
| | | | | | | layer | | | | | layer | | | | | layer |
| | 4 | SiO₂ | 33.4 | 0.40 | 1.37 | M2 | SiO₂ | 36.0 | 0.43 | 1.44 | M2 | SiO₂ | 33.4 | 0.40 | 1.37 | M2 |
| | 5 | TiO₂ | 29.0 | 0.57 | | layer | TiO₂ | 28.2 | 0.56 | | layer | TiO₂ | 29.0 | 0.57 | | layer |
| | 6 | SiO₂ | 33.7 | 0.40 | | | SiO₂ | 38.8 | 0.46 | | | SiO₂ | 33.7 | 0.40 | | |
| | 7 | TiO₂ | 128.0 | 2.53 | — | H2 | TiO₂ | 130.7 | 2.58 | — | H2 | TiO₂ | 128.0 | 2.53 | — | H2 |
| | | | | | | layer | | | | | layer | | | | | layer |
| | 8 | SiO₂ | 33.7 | 0.40 | 1.33 | M2 | SiO₂ | 42.3 | 0.50 | 1.51 | M2 | SiO₂ | 33.7 | 0.40 | 1.33 | M2 |
| | 9 | TiO₂ | 28.1 | 0.56 | | layer | TiO₂ | 25.0 | 0.49 | | layer | TiO₂ | 28.1 | 0.56 | | layer |
| | 10 | SiO₂ | 31.6 | 0.38 | | | SiO₂ | 43.7 | 0.52 | | | SiO₂ | 31.6 | 0.38 | | |
| | 11 | TiO₂ | 122.5 | 2.42 | — | H2 | TiO₂ | 127.9 | 2.52 | — | H2 | TiO₂ | 122.5 | 2.42 | — | H2 |
| | | | | | | layer | | | | | layer | | | | | layer |
| | 12 | SiO₂ | 29.1 | 0.35 | 1.26 | M2 | SiO₂ | 40.3 | 0.48 | 1.47 | M2 | SiO₂ | 29.1 | 0.35 | 1.26 | M2 |
| | 13 | TiO₂ | 28.1 | 0.55 | | layer | TiO₂ | 25.9 | 0.51 | | layer | TiO₂ | 28.1 | 0.55 | | layer |
| | 14 | SiO₂ | 30.4 | 0.36 | | | SiO₂ | 40.4 | 0.48 | | | SiO₂ | 30.4 | 0.36 | | |
| | 15 | TiO₂ | 125.5 | 2.48 | — | H2 | TiO₂ | 127.8 | 2.52 | — | H2 | TiO₂ | 125.5 | 2.48 | — | H2 |
| | | | | | | layer | | | | | layer | | | | | layer |
| | 16 | SiO₂ | 35.1 | 0.42 | 1.39 | M2 | SiO₂ | 40.5 | 0.48 | 1.49 | M2 | SiO₂ | 35.1 | 0.42 | 1.39 | M2 |
| | 17 | TiO₂ | 27.3 | 0.54 | | layer | TiO₂ | 26.0 | 0.51 | | layer | TiO₂ | 27.3 | 0.54 | | layer |
| | 18 | SiO₂ | 36.3 | 0.43 | | | SiO₂ | 41.6 | 0.49 | | | SiO₂ | 36.3 | 0.43 | | |
| | 19 | TiO₂ | 127.3 | 2.51 | — | H2 | TiO₂ | 129.1 | 2.55 | — | H2 | TiO₂ | 127.3 | 2.51 | — | H2 |
| | | | | | | layer | | | | | layer | | | | | layer |
| | 20 | SiO₂ | 34.6 | 0.41 | 1.36 | M2 | SiO₂ | 44.3 | 0.53 | 1.55 | M2 | SiO₂ | 34.6 | 0.41 | 1.36 | M2 |
| | 21 | TiO₂ | 27.7 | 0.55 | | layer | TiO₂ | 24.2 | 0.48 | | layer | TiO₂ | 27.7 | 0.55 | | layer |
| | 22 | SiO₂ | 34.1 | 0.40 | | | SiO₂ | 46.2 | 0.55 | | | SiO₂ | 34.1 | 0.40 | | |
| | 23 | TiO₂ | 126.4 | 2.49 | — | H2 | TiO₂ | 127.6 | 2.52 | — | H2 | TiO₂ | 126.4 | 2.49 | — | H2 |
| | | | | | | layer | | | | | layer | | | | | layer |
| | 24 | SiO₂ | 32.3 | 0.38 | 1.35 | M2 | SiO₂ | 43.1 | 0.51 | 1.49 | M2 | SiO₂ | 32.3 | 0.38 | 1.35 | M2 |
| | 25 | TiO₂ | 28.5 | 0.56 | | layer | TiO₂ | 25.2 | 0.50 | | layer | TiO₂ | 28.5 | 0.56 | | layer |
| | 26 | SiO₂ | 34.0 | 0.40 | | | SiO₂ | 40.6 | 0.48 | | | SiO₂ | 34.0 | 0.40 | | |
| | 27 | TiO₂ | 128.3 | 2.53 | — | H2 | TiO₂ | 123.8 | 2.44 | — | H2 | TiO₂ | 128.3 | 2.53 | — | H2 |
| | | | | | | layer | | | | | layer | | | | | layer |
| | 28 | SiO₂ | 37.8 | 0.45 | 1.45 | M2 | SiO₂ | 37.4 | 0.44 | 1.40 | M2 | SiO₂ | 37.8 | 0.45 | 1.45 | M2 |
| | 29 | TiO₂ | 26.5 | 0.52 | | layer | TiO₂ | 24.9 | 0.49 | | layer | TiO₂ | 26.5 | 0.52 | | layer |
| | 30 | SiO₂ | 40.3 | 0.48 | | | SiO₂ | 38.9 | 0.46 | | | SiO₂ | 40.3 | 0.48 | | |

| | Optical filter: Example 2-1 | | | | | Optical filter: Example 2-2 | | | | | Optical filter: Example 2-3 | | | | |
|---|---|---|---|---|---|---|---|---|---|---|---|---|---|---|---|
| | | | | Sum | | | | | Sum | | | | | Sum | |
| | | Physical | | of | | | Physical | | of | | | Physical | | of | |
| | Material | thickness | QWOT | QWOT | | Material | thickness | QWOT | QWOT | | Material | thickness | QWOT | QWOT | |
| 31 | TiO₂ | 127.8 | 2.52 | — | H2 | TiO₂ | 123.3 | 2.43 | — | H2 | TiO₂ | 127.8 | 2.52 | — | H2 |
| | | | | | layer | | | | | layer | | | | | layer |
| 32 | SiO₂ | 44.4 | 0.53 | 1.52 | M2 | SiO₂ | 47.6 | 0.56 | 1.57 | M2 | SiO₂ | 44.4 | 0.53 | 1.52 | M2 |
| 33 | TiO₂ | 23.4 | 0.46 | | layer | TiO₂ | 21.6 | 0.43 | | layer | TiO₂ | 23.4 | 0.46 | | layer |
| 34 | SiO₂ | 45.1 | 0.54 | | | SiO₂ | 49.0 | 0.58 | | | SiO₂ | 45.1 | 0.54 | | |
| 35 | TiO₂ | 125.2 | 2.47 | — | H2 | TiO₂ | 123.9 | 2.45 | — | H2 | TiO₂ | 125.2 | 2.47 | — | H2 |
| | | | | | layer | | | | | layer | | | | | layer |
| 36 | SiO₂ | 45.0 | 0.53 | 1.50 | M2 | SiO₂ | 48.4 | 0.57 | 1.54 | M2 | SiO₂ | 45.0 | 0.53 | 1.50 | M2 |
| 37 | TiO₂ | 22.6 | 0.45 | | layer | TiO₂ | 21.8 | 0.43 | | layer | TiO₂ | 22.6 | 0.45 | | layer |
| 38 | SiO₂ | 44.1 | 0.52 | | | SiO₂ | 45.3 | 0.54 | | | SiO₂ | 44.1 | 0.52 | | |
| 39 | TiO₂ | 121.1 | 2.39 | — | H2 | TiO₂ | 120.4 | 2.38 | — | H2 | TiO₂ | 121.1 | 2.39 | — | H2 |
| | | | | | layer | | | | | layer | | | | | layer |
| 40 | SiO₂ | 44.0 | 0.52 | 1.46 | M2 | SiO₂ | 43.0 | 0.51 | 1.46 | M2 | SiO₂ | 44.0 | 0.52 | 1.46 | M2 |
| 41 | TiO₂ | 20.9 | 0.41 | | layer | TiO₂ | 21.8 | 0.43 | | layer | TiO₂ | 20.9 | 0.41 | | layer |
| 42 | SiO₂ | 44.0 | 0.52 | | | SiO₂ | 43.4 | 0.51 | | | SiO₂ | 44.0 | 0.52 | | |
| 43 | TiO₂ | 118.0 | 2.33 | — | H2 | TiO₂ | 120.3 | 2.37 | — | H2 | TiO₂ | 118.0 | 2.33 | — | H2 |
| | | | | | layer | | | | | layer | | | | | layer |
| 44 | SiO₂ | 50.6 | 0.60 | 1.56 | M2 | SiO₂ | 51.7 | 0.61 | 1.60 | M2 | SiO₂ | 50.6 | 0.60 | 1.56 | M2 |
| 45 | TiO₂ | 17.1 | 0.34 | | layer | TiO₂ | 19.6 | 0.39 | | layer | TiO₂ | 17.1 | 0.34 | | layer |
| 46 | SiO₂ | 52.7 | 0.63 | | | SiO₂ | 50.3 | 0.60 | | | SiO₂ | 52.7 | 0.63 | | |
| 47 | TiO₂ | 107.9 | 2.13 | — | H2 | TiO₂ | 122.0 | 2.41 | — | H2 | TiO₂ | 107.9 | 2.13 | — | H2 |
| | | | | | layer | | | | | layer | | | | | layer |
| 48 | SiO₂ | 100.4 | 1.19 | — | — | SiO₂ | 49.4 | 0.59 | 1.49 | M2 | SiO₂ | 100.4 | 1.19 | — | |
| 49 | | | | | | TiO₂ | 20.8 | 0.41 | | layer | | | | | |
| 50 | | | | | | SiO₂ | 41.7 | 0.49 | | | | | | | |
| 51 | | | | | | TiO₂ | 117.4 | 2.32 | — | H2 | | | | | |
| | | | | | | | | | | layer | | | | | |
| 52 | | | | | | SiO₂ | 40.1 | 0.48 | 1.40 | | | | | | |
| 53 | | | | | | TiO₂ | 21.3 | 0.42 | | M2 | | | | | |
| 54 | | | | | | SiO₂ | 42.3 | 0.50 | | layer | | | | | |
| 55 | | | | | | TiO₂ | 109.8 | 2.17 | — | H2 | | | | | |
| | | | | | | | | | | layer | | | | | |
| 56 | | | | | | SiO₂ | 98.5 | 1.17 | — | — | | | | | |

TABLE 6

| | | Optical filter: Example 2-4 | | | | | Optical filter: Example 2-5 | | | | | Optical filter: Example 2-6 | | | | |
|---|---|---|---|---|---|---|---|---|---|---|---|---|---|---|---|---|
| | | | Phys- | | | | | Phys- | | | | | Phys- | | | |
| | | | ical | | Sum | | | ical | | Sum | | | ical | | Sum | |
| | | | thick- | | of | | | thick- | | of | | | thick- | | of | |
| | | Material | ness | QWOT | QWOT | | Material | ness | QWOT | QWOT | | Material | ness | QWOT | QWOT | |
| Dielectric | 14 | | | | | | | | | | | SiO₂ | 102.9 | 1.22 | 2.00 | — |
| multilayer | 13 | | | | | | | | | | | TiO₂ | 32.6 | 0.64 | | |
| film 1 | 12 | | | | | | | | | | | SiO₂ | 11.2 | 0.13 | | |
| | 11 | | | | | | | | | | | TiO₂ | 83.8 | 1.65 | — | H2 |
| | | | | | | | | | | | | | | | | layer |
| | 10 | | | | | | | | | | | SiO₂ | 31.9 | 0.38 | 5.86 | — |
| | | | | | | | | | | | | TiO₂ | 21.9 | 0.43 | | |
| | 9 | | | | | | | | | | | | | | | |
| | 8 | | | | | | | | | | | SiO₂ | 102.0 | 1.21 | | |
| | 7 | | | | | | | | | | | TiO₂ | 9.0 | 0.18 | | |
| | 6 | SiO₂ | 95.4 | 1.13 | — | — | SiO₂ | 95.4 | 1.13 | | | SiO₂ | 87.8 | 1.04 | | |
| | 5 | TiO₂ | 116.6 | 2.30 | — | H2 | TiO₂ | 116.6 | 2.30 | — | H2 | TiO₂ | 21.4 | 0.42 | | |
| | | | | | | layer | | | | | layer | | | | | |
| | 4 | SiO₂ | 40.0 | 0.47 | 1.71 | M2 | SiO₂ | 40.0 | 0.47 | 1.71 | M2 | SiO₂ | 59.4 | 0.70 | | |
| | 3 | TiO₂ | 18.5 | 0.37 | | layer | TiO₂ | 18.5 | 0.37 | | layer | TiO₂ | 23.5 | 0.46 | | |
| | 2 | SiO₂ | 63.3 | 0.75 | | | SiO₂ | 63.3 | 0.75 | | | SiO₂ | 65.4 | 0.78 | | |
| | 1 | TiO₂ | 6.0 | 0.12 | | | TiO₂ | 6.0 | 0.12 | | | TiO₂ | 12.6 | 0.25 | | |

| | | Resin film | | | | | | | | | | | | | | |
|---|---|---|---|---|---|---|---|---|---|---|---|---|---|---|---|---|
| | | Resin film 1-1 | | | | | Resin film 1-2 | | | | | Resin film 1-3 | | | | |
| | | Glass | | | | | | | | | | | | | | |
| | | Phosphate glass | | | | | Fluorophosphate glass 1 | | | | | Fluorophosphate glass 2 | | | | |
| Dielectric | 1 | TiO₂ | 6.0 | 0.12 | 1.71 | M2 | TiO₂ | 13.5 | 0.27 | — | — | TiO₂ | 13.0 | 0.26 | 0.64 | — |
| multilayer | 2 | SiO₂ | 63.3 | 0.75 | | layer | SiO₂ | 37.0 | 0.44 | — | — | SiO₂ | 32.4 | 0.38 | | |
| film 2 | 3 | TiO₂ | 18.5 | 0.37 | | | TiO₂ | 116.0 | 2.29 | — | H2 | TiO₂ | 122.1 | 2.41 | — | H2 |
| | | | | | | | | | | | layer | | | | | layer |
| | 4 | SiO₂ | 40.0 | 0.47 | | | SiO₂ | 181.7 | 2.16 | — | — | SiO₂ | 33.4 | 0.40 | 1.37 | M2 |
| | 5 | TiO₂ | 116.6 | 2.30 | — | H2 | TiO₂ | 108.9 | 2.15 | — | H2 | TiO₂ | 29.0 | 0.57 | | layer |
| | | | | | | layer | | | | | layer | | | | | |
| | 6 | SiO₂ | 95.4 | 1.13 | — | — | SiO₂ | 184.6 | 2.19 | — | — | SiO₂ | 33.7 | 0.40 | | |
| | 7 | | | | | | TiO₂ | 110.8 | 2.19 | — | H2 | TiO₂ | 128.0 | 2.53 | — | H2 |
| | | | | | | | | | | | layer | | | | | layer |
| | 8 | | | | | | SiO₂ | 186.3 | 2.21 | — | — | SiO₂ | 33.7 | 0.40 | 1.33 | M2 |
| | 9 | | | | | | TiO | 108.6 | 2.14 | — | H2 | TiO₂ | 28.1 | 0.56 | | layer |
| | | | | | | | | | | | layer | | | | | |
| | 10 | | | | | | SiO₂ | 184.1 | 2.18 | — | — | SiO₂ | 31.6 | 0.38 | | |
| | 11 | | | | | | TiO₂ | 110.1 | 2.17 | — | H2 | TiO₂ | 122.5 | 2.42 | — | H2 |
| | | | | | | | | | | | layer | | | | | layer |
| | 12 | | | | | | SiO₂ | 181.0 | 2.15 | — | — | SiO₂ | 29.1 | 0.35 | 1.26 | M2 |
| | 13 | | | | | | TiO₂ | 106.6 | 2.10 | — | H2 | TiO₂ | 28.1 | 0.55 | | layer |
| | | | | | | | | | | | layer | | | | | |
| | 14 | | | | | | SiO₂ | 180.3 | 2.14 | — | — | SiO₂ | 30.4 | 0.36 | | |
| | 15 | | | | | | TiO₂ | 106.6 | 2.10 | — | H2 | TiO₂ | 125.5 | 2.48 | — | H2 |
| | | | | | | | | | | | layer | | | | | layer |
| | 16 | | | | | | SiO₂ | 172.0 | 2.04 | — | — | SiO₂ | 35.1 | 0.42 | 1.39 | M2 |
| | 17 | | | | | | TiO₂ | 95.5 | 1.88 | — | H2 | TiO₂ | 27.3 | 0.54 | | layer |
| | | | | | | | | | | | layer | | | | | |
| | 18 | | | | | | SiO₂ | 157.6 | 1.87 | — | — | SiO₂ | 36.3 | 0.43 | | |
| | 19 | | | | | | TiO₂ | 89.8 | 1.77 | — | H2 | TiO₂ | 127.3 | 2.51 | — | H2 |
| | | | | | | | | | | | layer | | | | | layer |
| | 20 | | | | | | SiO₂ | 155.0 | 1.84 | — | — | SiO₂ | 34.6 | 0.41 | 1.36 | M2 |
| | 21 | | | | | | TiO₂ | 90.6 | 1.79 | — | H2 | TiO₂ | 27.7 | 0.55 | | layer |
| | | | | | | | | | | | layer | | | | | |
| | 22 | | | | | | SiO₂ | 168.0 | 1.99 | — | — | SiO₂ | 34.1 | 0.40 | | |
| | 23 | | | | | | TiO₂ | 102.3 | 2.02 | — | H2 | TiO₂ | 126.4 | 2.49 | — | H2 |
| | | | | | | | | | | | layer | | | | | layer |
| | 24 | | | | | | SiO₂ | 175.6 | 2.08 | — | — | SiO₂ | 32.3 | 0.38 | 1.35 | M2 |
| | 25 | | | | | | TiO₂ | 97.6 | 1.93 | — | H2 | TiO₂ | 28.5 | 0.56 | | layer |
| | | | | | | | | | | | layer | | | | | |
| | 26 | | | | | | SiO₂ | 156.0 | 1.85 | — | — | SiO₂ | 34.0 | 0.40 | | |

| | | Optical filter: Example 2-4 | | | | Optical filter: Example 2-5 | | | | | Optical filter: Example 2-6 | | | | |
|---|---|---|---|---|---|---|---|---|---|---|---|---|---|---|---|
| | | | Phys- | | | | Phys- | | | | | Phys- | | | |
| | | | ical | | Sum | | ical | | Sum | | | ical | | Sum | |
| | | | thick- | | of | | thick- | | of | | | thick- | | of | |
| | | Material | ness | QWOT | QWOT | Material | ness | QWOT | QWOT | | Material | ness | QWOT | QWOT | |
| Dielectric | 27 | | | | | TiO₂ | 88.0 | 1.74 | — | H2 | TiO₂ | 128.3 | 2.53 | | H2 |
| multilayer | | | | | | | | | | layer | | | | | layer |
| film 2 | 28 | | | | | SiO₂ | 149.3 | 1.77 | — | — | SiO₂ | 37.8 | 0.45 | 1.45 | M2 |
| | 29 | | | | | TiO₂ | 84.4 | 1.67 | — | H2 | TiO₂ | 26.5 | 0.52 | | layer |
| | | | | | | | | | | layer | | | | | |
| | 30 | | | | | SiO₂ | 145.1 | 1.72 | — | — | SiO₂ | 40.3 | 0.48 | | |
| | 31 | | | | | TiO₂ | 83.8 | 1.65 | — | H2 | TiO₂ | 127.8 | 2.52 | — | H2 |
| | | | | | | | | | | layer | | | | | layer |
| | 32 | | | | | SiO₂ | 145.9 | 1.73 | — | — | SiO₂ | 44.4 | 0.53 | 1.52 | M2 |
| | 33 | | | | | TiO₂ | 85.3 | 1.68 | | H2 | TiO₂ | 23.4 | 0.46 | | layer |
| | | | | | | | | | | layer | | | | | |
| | 34 | | | | | SiO₂ | 143.2 | 1.70 | — | — | SiO₂ | 45.1 | 0.54 | | |
| | 35 | | | | | TiO₂ | 83.7 | 1.65 | — | H2 | TiO₂ | 125.2 | 2.47 | — | H2 |
| | | | | | | | | | | layer | | | | | layer |
| | 36 | | | | | SiO₂ | 147.9 | 1.75 | — | — | SiO₂ | 45.0 | 0.53 | 1.50 | M2 |
| | 37 | | | | | TiO₂ | 87.1 | 1.72 | — | H2 | TiO₂ | 22.6 | 0.45 | | layer |
| | | | | | | | | | | layer | | | | | |
| | 38 | | | | | SiO₂ | 150.2 | 1.78 | | — | SiO₂ | 44.1 | 0.52 | | |
| | 39 | | | | | TiO₂ | 82.5 | 1.63 | — | H2 | TiO₂ | 121.1 | 2.39 | — | H2 |
| | | | | | | | | | | layer | | | | | layer |
| | 40 | | | | | SiO₂ | 70.5 | 0.84 | — | — | SiO₂ | 44.0 | 0.52 | 1.46 | M2 |
| | 41 | | | | | | | | | | TiO₂ | 20.9 | 0.41 | | layer |
| | 42 | | | | | | | | | | SiO₂ | 44.0 | 0.52 | | |
| | 43 | | | | | | | | | | TiO₂ | 118.0 | 2.33 | — | H2 |
| | | | | | | | | | | | | | | | layer |
| | 44 | | | | | | | | | | SiO₂ | 50.6 | 0.60 | 1.56 | M2 |
| | 45 | | | | | | | | | | TiO₂ | 17.1 | 0.34 | | layer |
| | 46 | | | | | | | | | | SiO₂ | 52.7 | 0.63 | | |
| | 47 | | | | | | | | | | TiO₂ | 107.9 | 2.13 | — | H2 |
| | | | | | | | | | | | | | | | layer |
| | 48 | | | | | | | | | | SiO₂ | 100.4 | 1.19 | — | |

With respect to each of the optical filters, spectral transmittance curves at an incident angle of 0 degrees and an incident angle of 60 degrees and a spectral reflectance curve at an incident angle of 5 degrees in the wavelength range of 350 nm to 1,200 nm were measured using the ultraviolet-visible spectrophotometer.

Results are shown in Table 7 below.

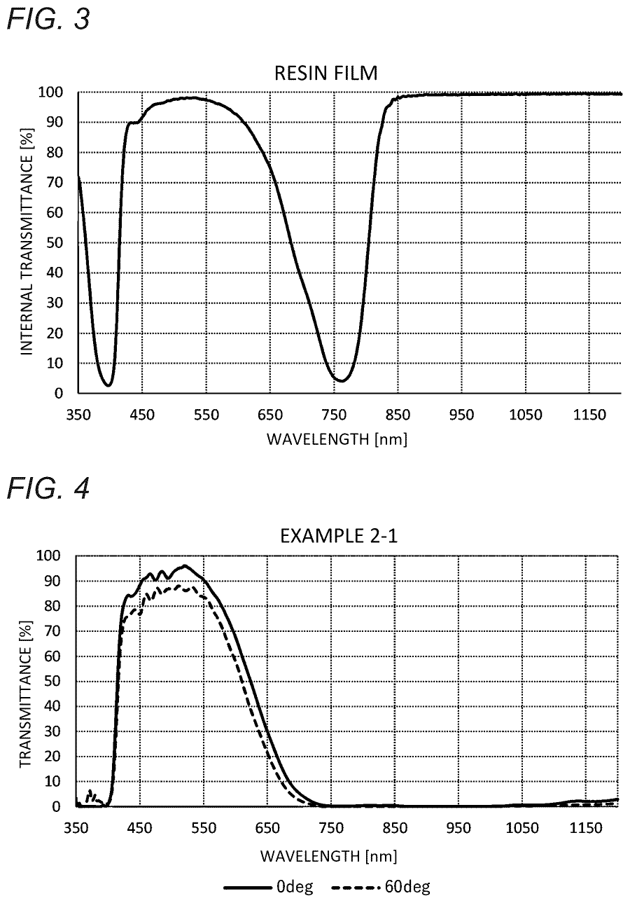

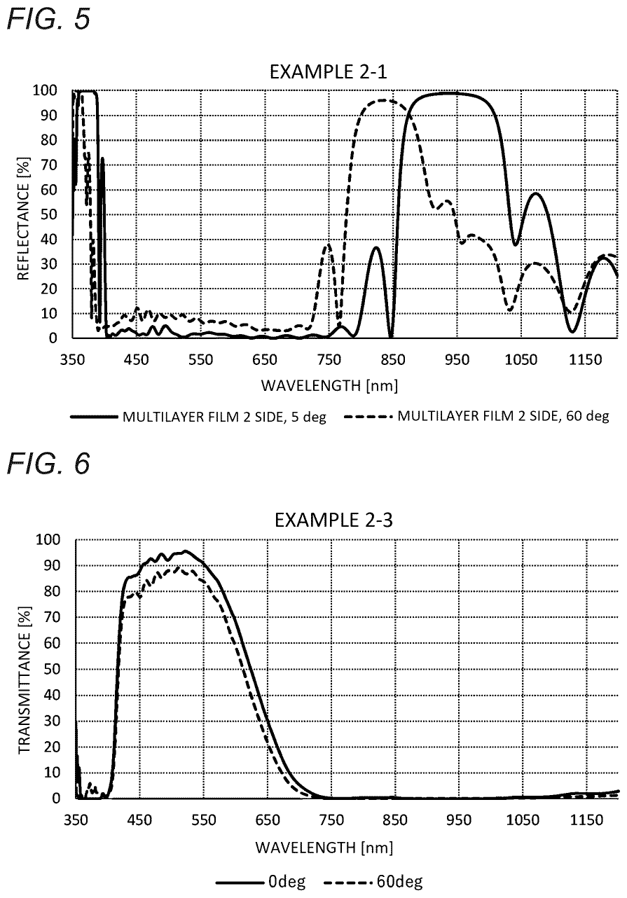

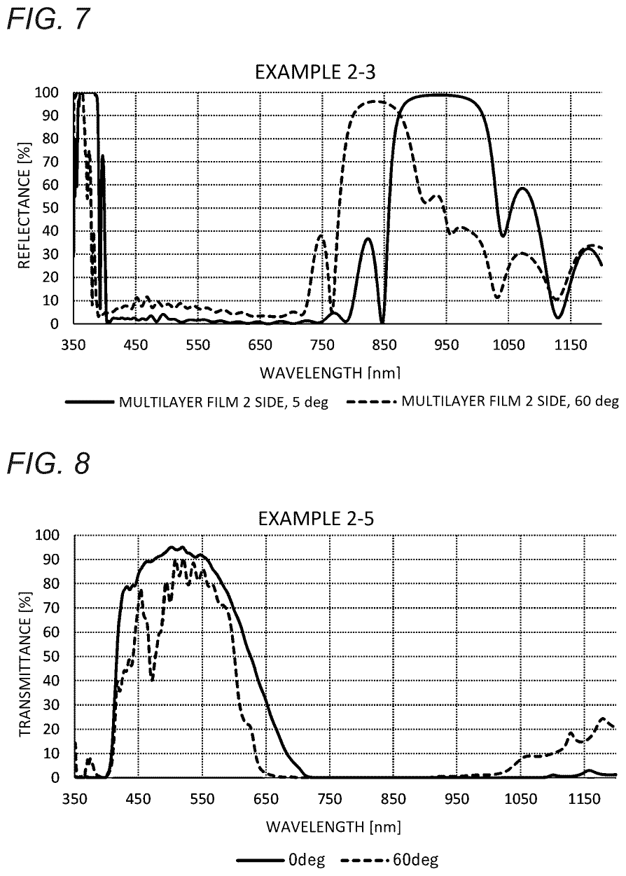

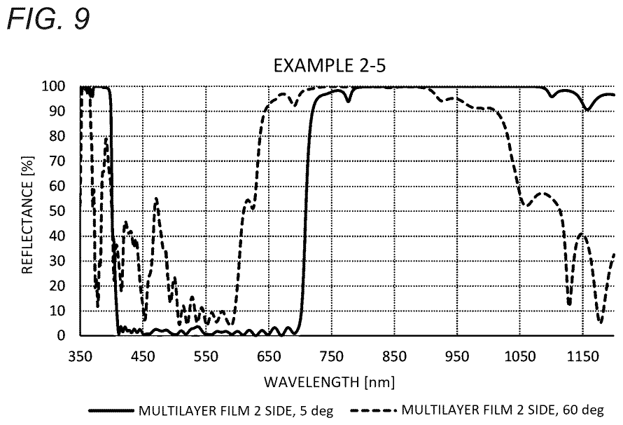

Spectral transmittance curves and spectral reflectance curves of the optical filter of Example 2-1 are illustrated in FIG. 4 and FIG. 5, respectively. Spectral transmittance curves and spectral reflectance curves of the optical filter of Example 2-3 are illustrated in FIG. 6 and FIG. 7, respectively. Spectral transmittance curves and spectral reflectance curves of the optical filter of Example 2-5 are illustrated in FIG. 8 and FIG. 9, respectively.

Examples 2-1 and 2-3 are inventive examples, and Examples 2-4 to 2-6 are comparative examples.

TABLE 7

| | Example | Example | Example | Example | Example | Example |
|---|---|---|---|---|---|---|
| Optical filter | 2-1 | 2-2 | 2-3 | 2-4 | 2-5 | 2-6 |
| 430-550 nm, 0 deg, average transmittance (%) | 91.5 | 91.4 | 91.8 | 92.8 | 89.5 | 92.9 |
| 430-550 nm, 60 deg, average transmittance (%) | 84.0 | 83.8 | 84.6 | 85.5 | 70.1 | 85.6 |
| 500-700 nm, 0 deg, wavelength at which transmittance is 50% | 624 nm | 624 nm | 624 nm | 624 nm | 626 nm | 622 nm |
| 900-1,000 nm, 0 deg, number of wavelengths at which | 101 | 101 | 101 | 0 | 101 | 62 |
| transmittance is 0.04% or less | | | | | | |
| 900-1,000 nm, 40 deg, number of wavelengths at which | 51 | 72 | 52 | 0 | 86 | 19 |
| transmittance is 0.04% or less | | | | | | |
| 750-1,200 nm, 0 deg, average transmittance (%) | 0.6 | 0.6 | 0.6 | 0.9 | 0.3 | 2.9 |
| 750-1,200 nm, 40 deg, average transmittance (%) | 0.5 | 0.4 | 0.5 | 0.5 | 2.8 | 2.5 |
| 900-1,000 nm, 0 deg, number of wavelengths at which | 74 | 101 | 76 | 0 | 101 | 0 |
| transmittance is 0.01% or less | | | | | | |
| 900-1,000 nm, 40 deg, number of wavelengths at which | 30 | 59 | 31 | 0 | 58 | 0 |
| transmittance is 0.01% or less | | | | | | |
| 430-550 nm, absolute value of difference between average | 7.5 | 7.7 | 7.2 | 7.3 | 19.4 | 7.3 |
| transmittance at 0 deg and average transmittance at 60 deg (%) | | | | | | |
| 430-550 nm, absolute value of difference between maximum | 7.8 | 6.9 | 6.3 | 6.9 | 4.6 | 8.0 |
| transmittance at 0 deg and maximum transmittance at 60 deg (%) | | | | | | |
| 430-550 nm, 5 deg, average reflectance on multilayer film 2 side | 2.3 | 2.4 | 2.0 | 1.0 | 1.6 | 2.3 |
| (%) | | | | | | |
| 430-550 nm, 60 deg, average reflectance on multilayer film 2 | 8.7 | 9.0 | 8.2 | 7.2 | 21.6 | 8.8 |
| side (%) | | | | | | |
| 430-550 nm, 5 deg, maximum reflectance on multilayer film 2 | 5.0 | 4.7 | 4.0 | 2.1 | 3.4 | 4.7 |
| side (%) | | | | | | |
| 430-550 nm, 60 deg, maximum reflectance on multilayer film 2 | 12.3 | 15.0 | 11.7 | 8.0 | 55.1 | 11.9 |
| side (%) | | | | | | |
| 900-1,000 nm, 5 deg, number of wavelengths at which | 97 | 101 | 97 | 0 | 101 | 97 |
| reflectance is 95% or more on multilayer film 2 side | | | | | | |
| 900-1,000 nm, 40 deg, number of wavelengths at which | 32 | 63 | 32 | 0 | 101 | 32 |
| reflectance is 95% or more on multilayer film 2 side | | | | | | |
| 430-550 nm, absolute value of difference between average | 6.4 | 6.6 | 6.2 | 6.2 | 20.0 | 6.5 |
| reflectance at 5 deg and average reflectance at 60 deg on | | | | | | |
| multilayer film 2 side (%) | | | | | | |
| 430-550 nm, absolute value of difference between maximum | 7.3 | 10.3 | 7.7 | 5.9 | 51.7 | 7.2 |
| reflectance at 5 deg and maximum reflectance at 60 deg on | | | | | | |
| multilayer film 2 side (%) | | | | | | |
| 900-1,000 nm, 40 deg, number of wavelengths at which | 74 | 101 | 74 | 0 | 101 | 74 |
| reflectance is 98% or more on multilayer film 2 side | | | | | | |
| Sum of QWOT of high refractive index film/sum of QWOT of low | 1.8 | 1.6 | 1.8 | 0.7 | 0.6 | 1.8 |
| refractive index film in dielectric multilayer film 2 | | | | | | |
| Total number of laminated H2 layers and M2 layers in dielectric | 24 | 28 | 24 | 3 | 20 | 24 |
| multilayer film 2 | | | | | | |

Based on the above results, it is understood that the optical filters of Examples 2-1 to 2-3 are filters having a high transmittance in the visible light region and high light-shielding properties in the near-infrared light region and in which the ripple generation is prevented since a change in transmittance of the visible light is small even at a high incident angle.

In the optical filter of Example 2-4, the number of wavelengths at which the transmittance at the wavelength of 900 nm to 1,000 nm is 0.04% or less is 0 at both incident angles of 0 degrees and 40 degrees, and the light-shielding properties in the near-infrared light region is low. The reason for this is considered to be that all of the dielectric multilayer films of Examples 2-4 were designed as antireflection layers, and light in particularly the near-infrared light region having a wavelength of 900 nm to 1,000 nm could not be sufficiently shielded only by the absorption characteristics of the phosphate glass and the near-infrared ray absorbing dye.

In the optical filter of Example 2-5, an average transmittance at 60 degrees is small in the visible light region, and a difference between an average transmittance at an incident angle of 0 degrees and the average transmittance at an incident angle of 60 degrees is large, that is, a transmittance of visible light is reduced at a high incident angle. It is considered that since the reflection characteristics of the dielectric multilayer film 2 in Example 2-5 in the near-infrared light region are large, a ripple is likely to be generated in the visible light region at a high incident angle.

In the optical filter of Example 2-6, the number of wavelengths at which the transmittance is 0.04% or less at the wavelength of 900 nm to 1,000 nm is small at an incident angle of 40 degrees. It is considered that since the phosphate glass was not used in Example 2-6, light in the near-infrared light region could not be sufficiently shielded.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2022-138363) filed on Aug. 31, 2022, the content of which is incorporated herein by reference.

### INDUSTRIAL APPLICABILITY

The optical filter according to the present embodiment has spectral characteristics of an excellent transmittance of visible light, small change in transmittance in the visible light region even at a high incident angle, and excellent light-shielding properties in the near-infrared light region. In recent years, the optical filter is useful for applications of imaging devices such as cameras and sensors for transport machines, for which high performance has been achieved.

### REFERENCE SIGNS LIST

1: optical filter

A1: dielectric multilayer film

A2: dielectric multilayer film

11: phosphate glass

12: resin film

1. An optical filter comprising a dielectric multilayer film 1, a resin film, a phosphate glass, and a dielectric multilayer film 2 in this order,
wherein the resin film comprises a resin and a near-infrared ray absorbing dye having a maximum absorption wavelength in 690 nm to 800 nm in the resin,
the resin film has a thickness of 10 μm or less, and
the optical filter satisfies all of the following spectral characteristics (i-1) to (i-5):
(i-1) an average transmittance T_{430-550(0deg)AVE} at a wavelength of 430 nm to 550 nm and an incident angle of 0 degrees is 80% or more
(i-2) an average transmittance T_{430-550(60deg)AVE} at a wavelength of 430 nm to 550 nm and an incident angle of 60 degrees is 80% or more
(i-3) in a wavelength of 500 nm to 700 nm, a wavelength IR_{50(0deg)} at which a transmittance at an incident angle of 0 degrees is 50% is in a wavelength region of 600 nm to 660 nm
(i-4) when a transmittance T_{n(0deg)} (n: any integer) at each wavelength is read at an incident angle of 0 degrees and an interval of 1 nm from a wavelength of 900 nm toward a wavelength of 1,000 nm, the number of n at which the transmittance T_{n(0deg)} is 0.04% or less is 20 or more, and
(i-5) when a transmittance T_{n(40deg)} (n: any integer) at each wavelength is read at an incident angle of 40 degrees and an interval of 1 nm from a wavelength of 900 nm toward a wavelength of 1,000 nm, the number of n at which the transmittance T_{n(40deg)} is 0.04% or less is 20 or more.

2. The optical filter according to claim 1, further satisfying the following spectral characteristics (i-6) and (i-7):
(i-6) an average transmittance T_{750-1200(0deg)AVE} at a wavelength of 750 nm to 1,200 nm and an incident angle of 0 degrees is 2% or less, and
(i-7) an average transmittance T_{750-1200(40deg)AVE} at a wavelength of 750 nm to 1,200 nm and an incident angle of 40 degrees is 2% or less.

3. The optical filter according to claim 1, further satisfying the following spectral characteristics (i-8) and (i-9):
(i-8) when the transmittance T_{n(0deg)} (n: any integer) at each wavelength is read at an incident angle of 0 degrees and an interval of 1 nm from a wavelength of 900 nm toward a wavelength of 1,000 nm, the number of n at which the transmittance T_{n(0deg)} is 0.01% or less is 20 or more
(i-9) when the transmittance T_{n(40deg)} (n: any integer) at each wavelength is read at an incident angle of 40 degrees and an interval of 1 nm from a wavelength of 900 nm toward a wavelength of 1,000 nm, the number of n at which the transmittance T_{n(40deg)} is 0.01% or less is 20 or more.

4. The optical filter according to claim 1, further satisfying the following spectral characteristics (i-10) and (i-11):
(i-10) an absolute value of a difference between the average transmittance T_{430-550(0deg)AVE} and the average transmittance T_{430-550(60deg)AVE} is 10% or less
(i-11) an absolute value of a difference between a maximum transmittance T_{430-550(0deg)MAX} at an incident angle of 0 degrees and a maximum transmittance T_{430-550(60deg)MAX} at an incident angle of 60 degrees at a wavelength of 430 nm to 550 nm is 10% or less.

5. The optical filter according to claim 1, further satisfying the following spectral characteristics (i-12) to (i-17):
(i-12) when a dielectric multilayer film 2 side is set as an incident direction, an average reflectance R2_{430-550(5deg)AVE} at a wavelength of 430 nm to 550 nm and an incident angle of 5 degrees is 10% or less
(i-13) when a dielectric multilayer film 2 side is set as an incident direction, an average reflectance R2_{430-550(60deg)AVE} at a wavelength of 430 nm to 550 nm and an incident angle of 60 degrees is 10% or less
(i-14) when a dielectric multilayer film 2 side is set as an incident direction, a maximum reflectance R2_{430-550(5deg)MAX} at a wavelength of 430 nm to 550 nm and an incident angle of 5 degrees is 15% or less
(i-15) when a dielectric multilayer film 2 side is set as an incident direction, a maximum reflectance R2_{430-550(60deg)MAX} at a wavelength of 430 nm to 550 nm and an incident angle of 60 degrees is 15% or less
(i-16) when a dielectric multilayer film 2 side is set as an incident direction, when a reflectance R2_{n(5deg)} (n: any integer) at each wavelength is read at an incident angle of 5 degrees and an interval of 1 nm from a wavelength of 900 nm toward a wavelength of 1,000 nm, the number of n at which the reflectance R2_{n(5deg)} is 95% or more is 30 or more
(i-17) when a dielectric multilayer film 2 side is set as an incident direction, when a reflectance R2_{n(40deg)} (n: any integer) at each wavelength is read at an incident angle of 40 degrees and an interval of 1 nm from a wavelength of 900 nm toward a wavelength of 1,000 nm, the number of n at which the reflectance R2_{n(40deg)} is 95% or more is 25 or more.

6. The optical filter according to claim 1, further satisfying the following spectral characteristics (i-18) and (i-19):
(i-18) when a dielectric multilayer film 2 side is set an an incident direction, an absolute value of a difference between an average reflectance R2_{430-550(5deg)AVE} at an incident angle of 5 degrees and an average reflectance R2_{430-550(60deg)AVE} at an incident angle of 60 degrees at a wavelength of 430 nm to 550 nm is 10% or less
(i-19) when a dielectric multilayer film 2 side is set as an incident direction, an absolute value of a difference between a maximum reflectance R2_{430-550(5deg)MAX} at an incident angle of 5 degrees and a maximum reflectance R2_{430-550(60deg)MAX} at an incident angle of 60 degrees at a wavelength of 430 nm to 550 nm is 10% or less.

7. The optical filter according to claim 1, further satisfying the following spectral characteristic (i-20):
(i-20) when a dielectric multilayer film 2 side is set as an incident direction, when a reflectance R2_{n(5deg)} (n: any integer) at each wavelength is read at an incident angle of 5 degrees and an interval of 1 nm from a wavelength of 900 nm toward a wavelength of 1,000 nm, the number of n at which the reflectance R2_{n(5deg)} is 98% or more is 30 or more.

8. The optical filter according to claim 1,
wherein at least one of the dielectric multilayer film 1 and the dielectric multilayer film 2 is a laminate of dielectric films having different refractive indices, and has [sum of QWOT of dielectric films having relatively high refractive index]/[sum of QWOT of dielectric films having relatively low refractive index] of 1.6 or more.

9. The optical filter according to claim 1,
wherein at least one of the dielectric multilayer film 1 and the dielectric multilayer film 2 is a multilayer film in which H₂ layers and M₂ layers defined below are alternately laminated in 10 or more layers:
H₂ layer: a single layer having a refractive index of 1.8 or more and 2.5 or less and a QWOT of 1.1 or more and 3.5 or less
M₂ layer: a single layer or a multilayer present between two H₂ layers and having a sum of QWOT of 1.2 or more and 1.8 or less.

10. The optical filter according to claim 1,
wherein the phosphate glass satisfies all of the following spectral characteristics (ii-1) to (ii-5):
(ii-1) an internal transmittance T₄₅₀ at a wavelength of 450 nm is 92% or more
(ii-2) an average internal transmittance T_{450-600AVE} at a wavelength of 450 nm to 600 nm is 90% or more
(ii-3) IR50 at which an internal transmittance is 50% is in a wavelength range of 625 nm to 650 nm
(ii-4) an average internal transmittance T_{750-1000AVE} at a wavelength of 750 nm to 1,000 nm is 2.5% or less
(ii-5) an average internal transmittance T_{1000-1200AVE} at a wavelength of 1,000 nm to 1,200 nm is 7% or less.

11. The optical filter according to claim 1,
wherein the phosphate glass comprises, in terms of mass % based on oxide,
40% to 80% of P₂O₅,
0.5% to 20% of Al₂O₃,
0.5% to 20% of ΣR₂O (where R₂O is one or more components selected from Li₂O, Na₂O, K₂O, Rb₂O, and Cs₂O, and ΣR₂O is a total content of R₂O),
0% to 40% of ΣR′O (where R′O is one or more components selected from CaO, MgO, BaO, SrO, and ZnO, and ΣR′O is a total content of R′O), and
0.5% to 40% of CuO.

12. The optical filter according to claim 1,
wherein the near-infrared ray absorbing dye comprises a squarylium dye, and
the resin film satisfies all of the following spectral characteristics (iii-1) to (iii-3):
(iii-1) an internal transmittance T₄₅₀ at a wavelength of 450 nm is 85% or more
(iii-2) an average internal transmittance T_{450-600AVE} at a wavelength of 450 nm to 600 nm is 90% or more, and
(iii-3) a wavelength IR50 at which an internal transmittance is 50% is in a range of 620 nm to 750 nm.

13. An imaging device comprising the optical filter according to claim 1.
